(19) United States
(12) Patent Application Publication
(10) Pub. No.: US 2025/0334778 A1
(43) Pub. Date: Oct. 30, 2025

(54) IMAGING OPTICAL SYSTEM

(71) Applicant: SIGMA CORPORATION, Kanagawa (JP)

(72) Inventor: Ryosuke SATO, Kanagawa (JP)

(73) Assignee: SIGMA CORPORATION, Kanagawa (JP)

(21) Appl. No.: 19/184,203

(22) Filed: Apr. 21, 2025

(30) Foreign Application Priority Data
Apr. 26, 2024 (JP) 2024-072064

(51) Int. Cl. G02B 13/00; G02B 5/00; G02B 7/02; G02B 15/14

(52) U.S. Cl. CPC G02B 13/0045; G02B 5/005; G02B 7/025; G02B 13/006; G02B 13/009; G02B 15/145515

(57) ABSTRACT

An imaging optical system includes, in order from an object side to an image side, a first lens group, a second lens group, a third lens group having a positive refractive power, a fourth lens group having a positive refractive power, and a fifth lens group having a negative refractive power, in which, when focusing from an infinite distance object to a close distance object, the first lens group remains stationary with respect to an image surface, the second lens group moves to the object side along an optical axis, the third lens group remains stationary with respect to the image surface, the fourth lens group moves to the object side along the optical axis, and the fifth lens group remains stationary with respect to the image surface, the imaging optical system includes an aperture diaphragm, and the imaging optical system satisfies a predetermined conditional expression.

### TECHNICAL FIELD

The present invention relates to an imaging optical system suitable for an imaging lens used in an imaging apparatus such as a digital camera or a video camera.

### BACKGROUND ART

In an imaging lens used in an imaging apparatus such as a digital camera, an imaging optical system having a large aperture ratio with a bright F-number is required for reasons such as an increase in the amount of blurriness before and after a focus distance of an object, which widens the width of image expression that takes advantage of blurriness, and an increase in a degree of suppression of camera shake and subject shake due to a decrease in an exposure time. In the related art, for example, the following patent documents are known as imaging optical systems having a large aperture ratio.

### RELATED ART DOCUMENTS

### Patent Documents

[Patent Document 1] JP7123383B
[Patent Document 2] WO2022/059463

### SUMMARY OF THE INVENTION

### Problem that the Invention is to Solve

In recent years, in an imaging lens used in an imaging apparatus such as a digital camera, it is required to have high image formation performance with an increase in the number of pixels of an image sensor. In addition, with an increase in the number of small and lightweight cameras due to mirrorless cameras, there is a demand for a reduction in size and weight of an imaging optical system of an imaging lens combined with the camera. It is also required to achieve high performance as well as small size and light weight, in an imaging optical system with a large aperture ratio.

In addition, in recent years, there is a demand for high-speed auto focus and quietness during focus driving, and it is advantageous to reduce the weight of the focus lens group for this purpose. In addition, in recent years, capturing of a video using a digital camera has become common. In an imaging optical system used for video capturing, it is required to suppress a change in angle of view in a case where the focusing is changed to different focusing positions, so-called focus breathing.

The optical system disclosed in Patent Document 1 realizes high image formation performance with a large aperture ratio with a maximum aperture of about F1.25, and in some examples, the amount of focus breathing is also small. However, there is a problem in that it is difficult to achieve sufficient reduction in size and weight because the total length of the entire optical system is large and the weight of the glass material is heavy. In addition, there is a problem in that the number of lenses in the focus lens group is large and it is difficult to reduce the weight of the focus lens group. The optical system disclosed in Patent Document 2 realizes high image formation performance with a maximum aperture of about F1.44, which is a large aperture ratio, and further suppresses the total length of the entire optical system and the weight of the glass material. However, there is a problem in that focus breathing during focusing is large, and the number of lenses in the focus lens group is large, making it difficult to reduce the weight of the focus lens groups.

The present invention has been made in view of such circumstances, and an object of the present invention is to provide an imaging optical system that achieves both high imaging performance and reduction in size and weight while having a large aperture ratio, has a lightweight focus lens group, and suppresses focus breathing during focusing.

### Means for Solving the Problem

In order to achieve the above object, an imaging optical system according to an aspect of the present invention includes, in order from an object side to an image side, a first lens group G1, a second lens group G2, a third lens group G3 having a positive refractive power, a fourth lens group G4 having a positive refractive power, and a fifth lens group G5 having a negative refractive power, in which, when focusing from an infinite distance object to a close distance object, the first lens group G1 remains stationary with respect to an image surface, the second lens group G2 moves to the object side along an optical axis, the third lens group G3 remains stationary with respect to the image surface, the fourth lens group G4 moves to the object side along the optical axis, and the fifth lens group G5 remains stationary with respect to the image surface, the imaging optical system includes an aperture diaphragm S between a lens surface in the second lens group G2 closest to the image side and a lens surface in the fourth lens group G4 closest to the object side, and the imaging optical system satisfies a conditional expression shown below.

$$0.3 < D 24 / LT < 0.65 \qquad ( 1 )$$

where
D24: a distance from the lens surface in the second lens group G2 closest to the image side to the lens surface in the fourth lens group G4 closest to the object side at infinity focusing
LT: a distance from a lens surface in an entire lens system closest to the object side to the image surface at the infinity focusing

Further, an imaging optical system according to an aspect of the present invention includes, in order from an object side to an image side, a first lens group G1, a second lens group G2, a third lens group G3 having a positive refractive power, a fourth lens group G4 having a positive refractive power, and a fifth lens group G5 having a negative refractive power, in which, when focusing from an infinite distance object to a close distance object, the first lens group G1 remains stationary with respect to an image surface, the second lens group G2 moves to the object side along an optical axis, the third lens group G3 remains stationary with respect to the image surface, the fourth lens group G4 moves to the object side along the optical axis, and the fifth lens group G5 remains stationary with respect to the image surface, the imaging optical system includes an aperture diaphragm S between a lens surface in the second lens group G2 closest to the image side and a lens surface in the fourth lens group G4 closest to the object side, the fifth lens group G5 includes at least one positive lens, and the imaging optical system satisfies conditional expressions shown below.

$$θ gF min 5 p - 0.6483 + 0.0018 \times vd min 5 p > 0.025 \qquad ( 2 )$$

$$vd min 5 p < 24. \qquad ( 3 )$$

where
θgFmin5p: a partial dispersion ratio of a positive lens having minimum Abbe number of the at least one positive lens included in fifth lens group G5 with respect to a g line and an F line
νdmin5p: an Abbe number of a positive lens having a minimum Abbe number of the at least one positive lens included in the fifth lens group G5, with respect to a d line

### Advantage of the Invention

According to the imaging optical system of the present invention, it is possible to provide an imaging optical system that achieves both high imaging performance and reduction in size and weight while having a large aperture ratio, has a lightweight focus lens group, and suppresses focus breathing during focusing.

### BRIEF DESCRIPTION OF THE DRAWINGS

FIG. 1 is a lens configuration diagram according to Example 1 of an imaging optical system of the present invention.

FIG. 2 is a longitudinal aberration diagram of the imaging optical system of Example 1 at infinity focusing.

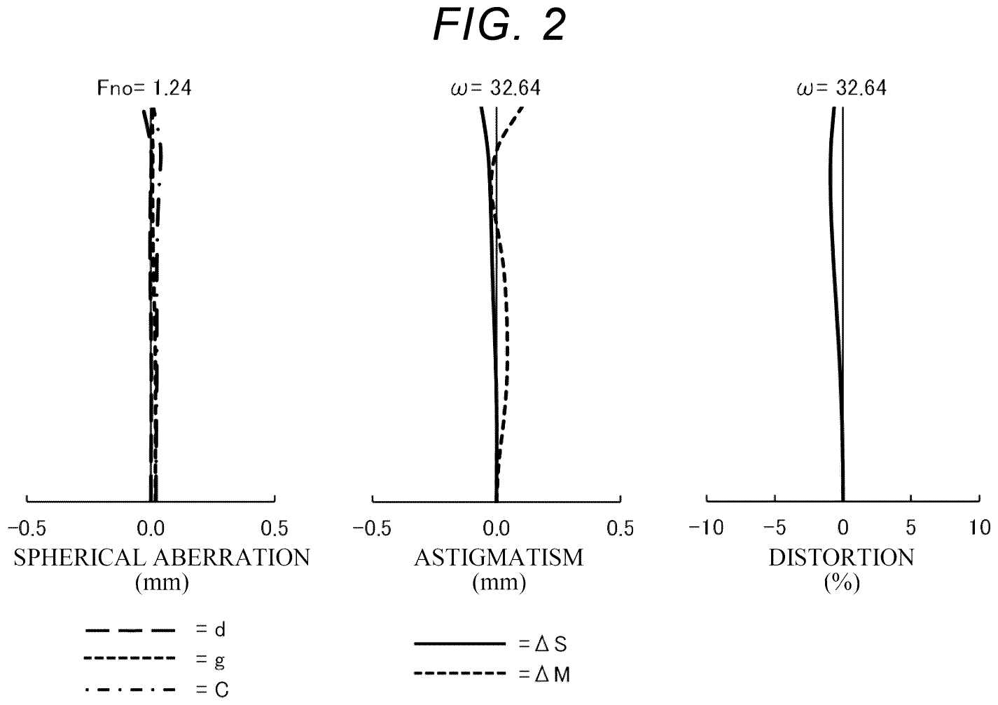

FIG. 3 is a longitudinal aberration diagram at a focusing distance of 1462 mm of the imaging optical system of Example 1.

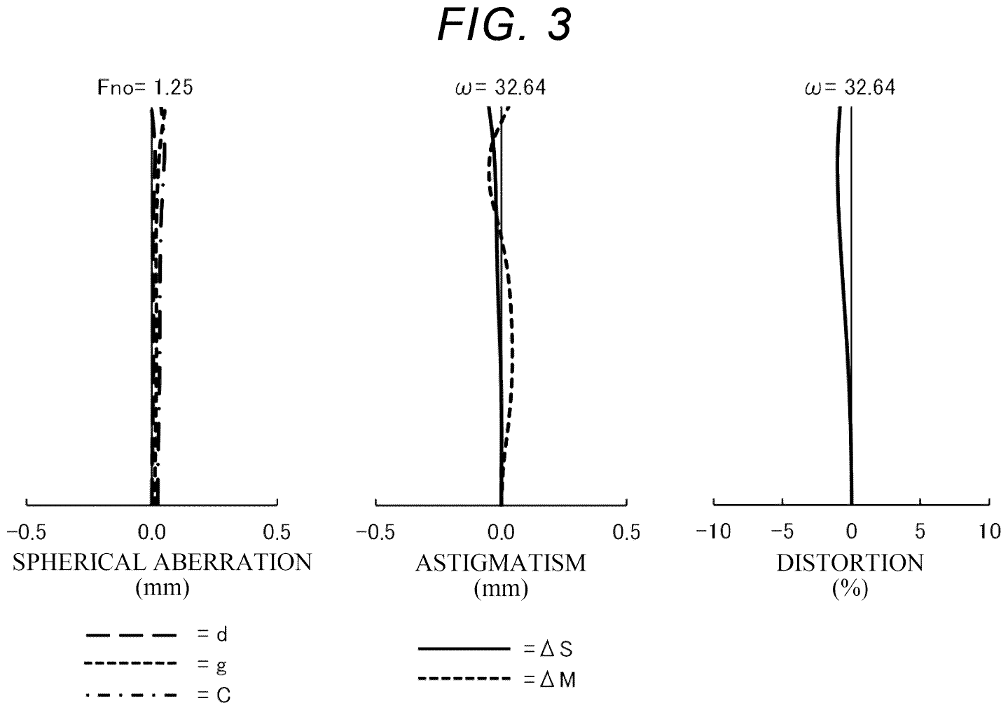

FIG. 4 is a lateral aberration diagram of the imaging optical system of Example 1 at infinity focusing.

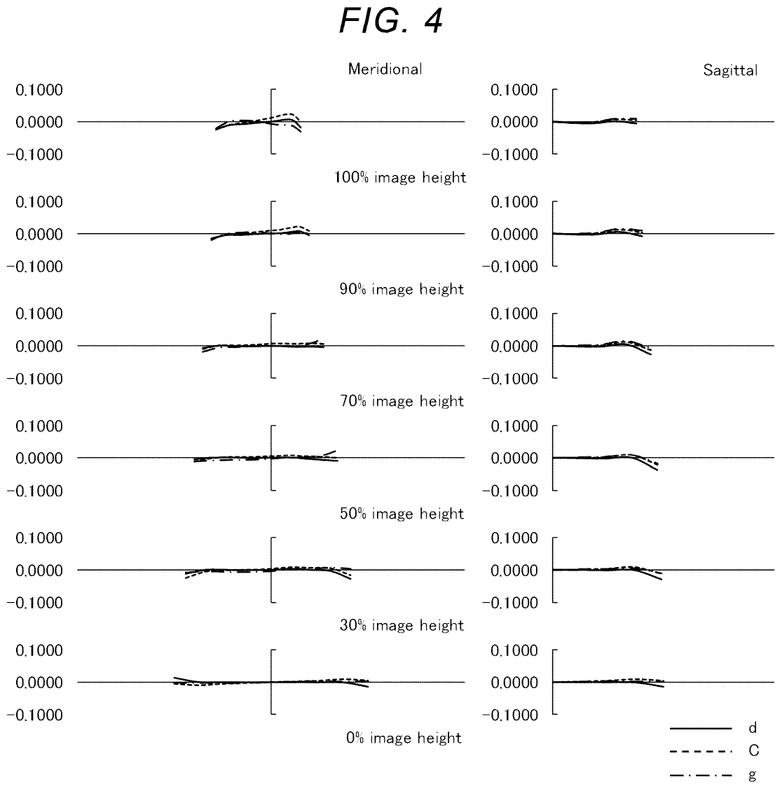

FIG. 5 is a lateral aberration diagram at a focusing distance of 1462 mm of the imaging optical system of Example 1.

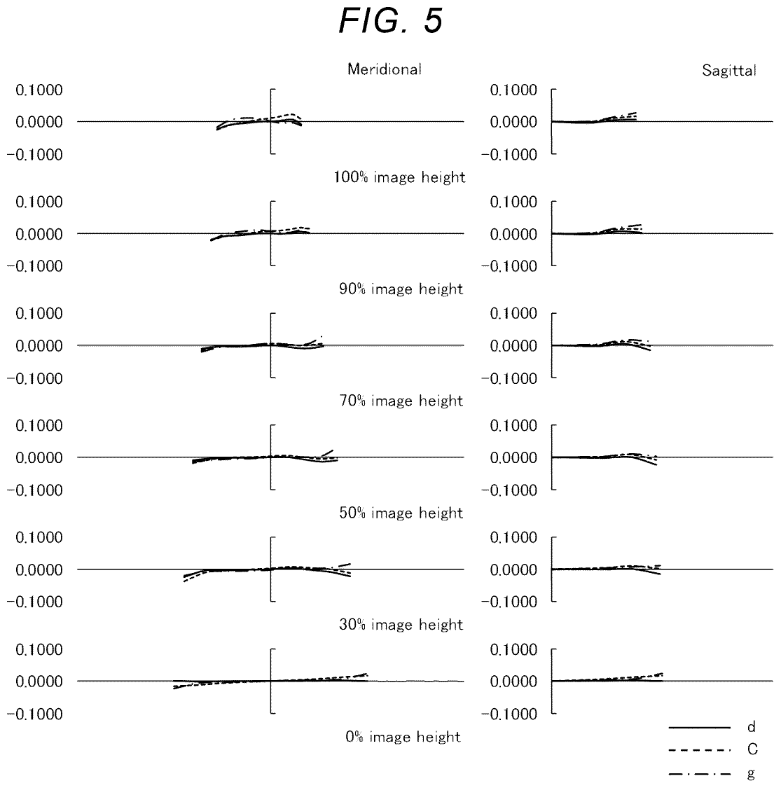

FIG. 6 is a lens configuration diagram according to Example 2 of the imaging optical system of the present invention.

FIG. 7 is a longitudinal aberration diagram of the imaging optical system of Example 2 at infinity focusing.

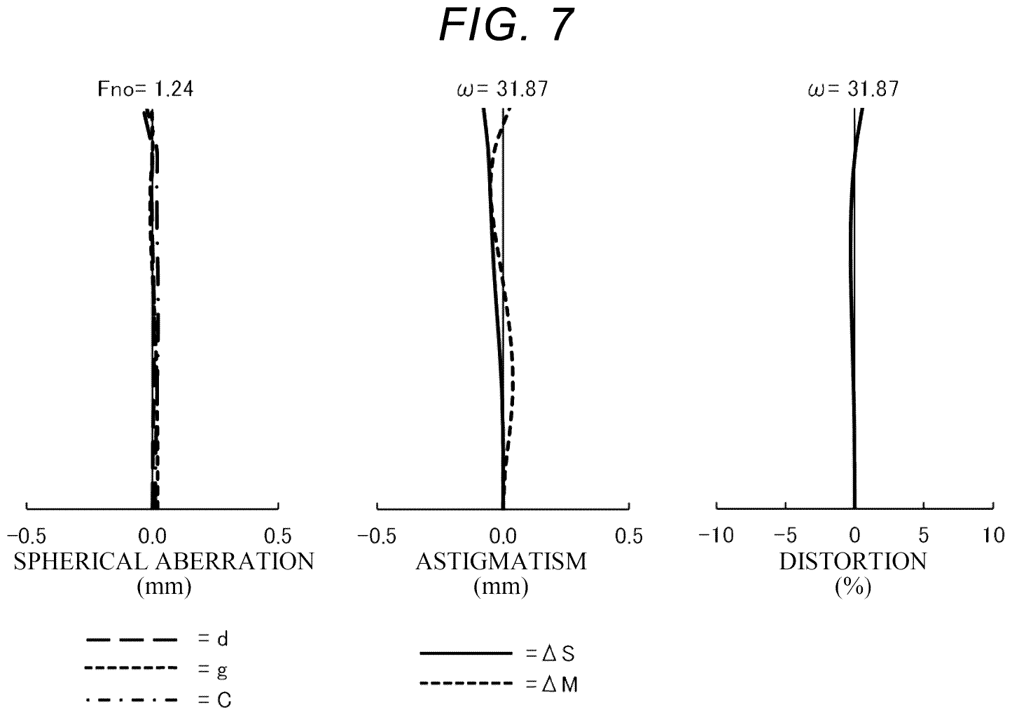

FIG. 8 is a longitudinal aberration diagram at a focusing distance of 1477 mm in the imaging optical system of Example 2.

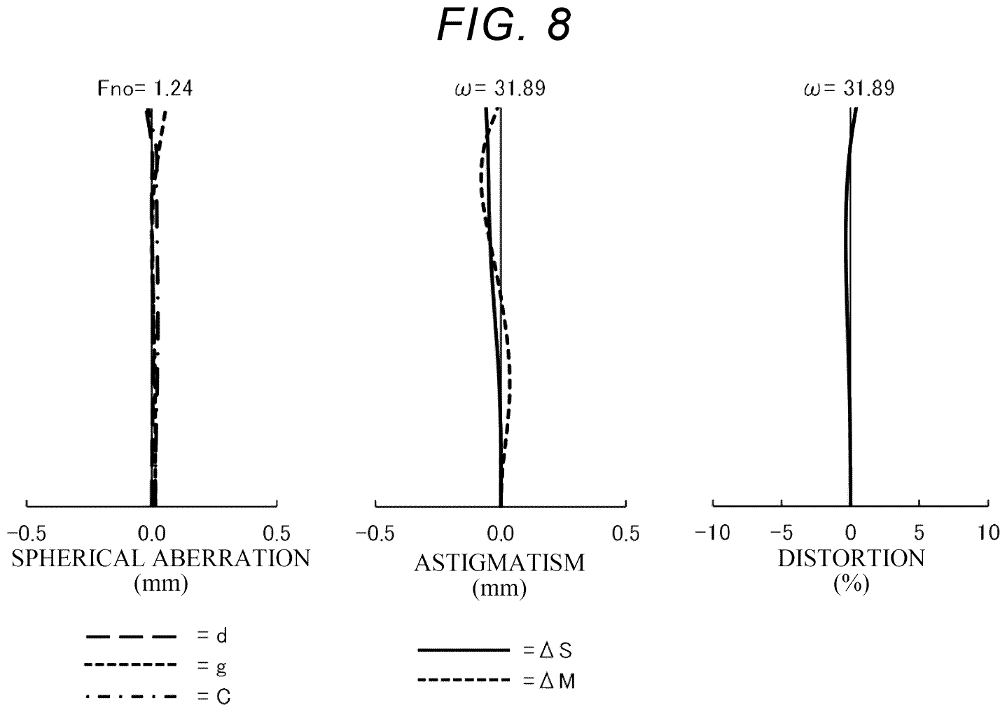

FIG. 9 is a lateral aberration diagram at infinity focusing in the imaging optical system of Example 2.

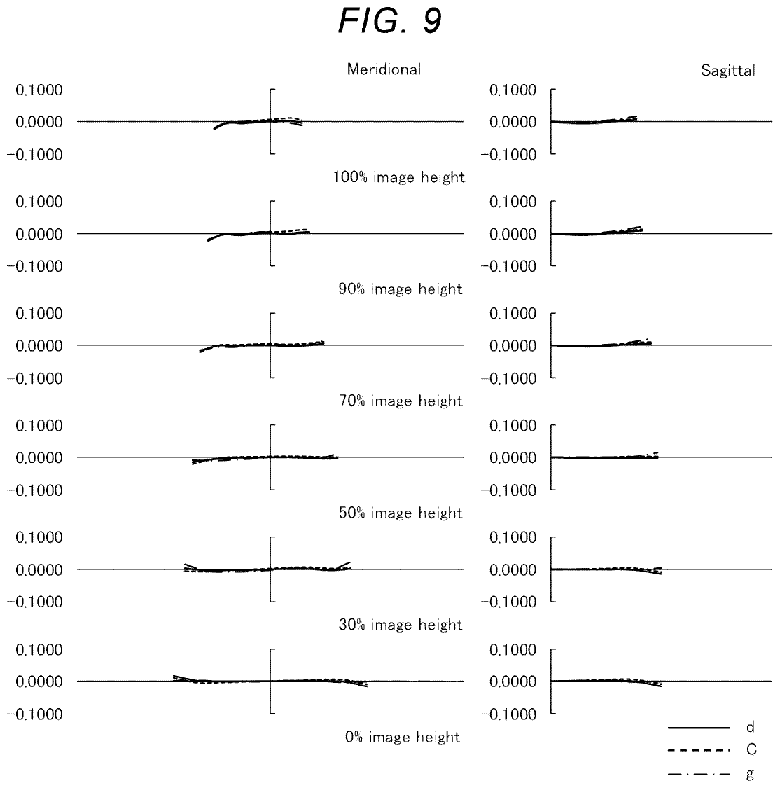

FIG. 10 is a lateral aberration diagram at a focusing distance of 1477 mm in the imaging optical system of Example 2.

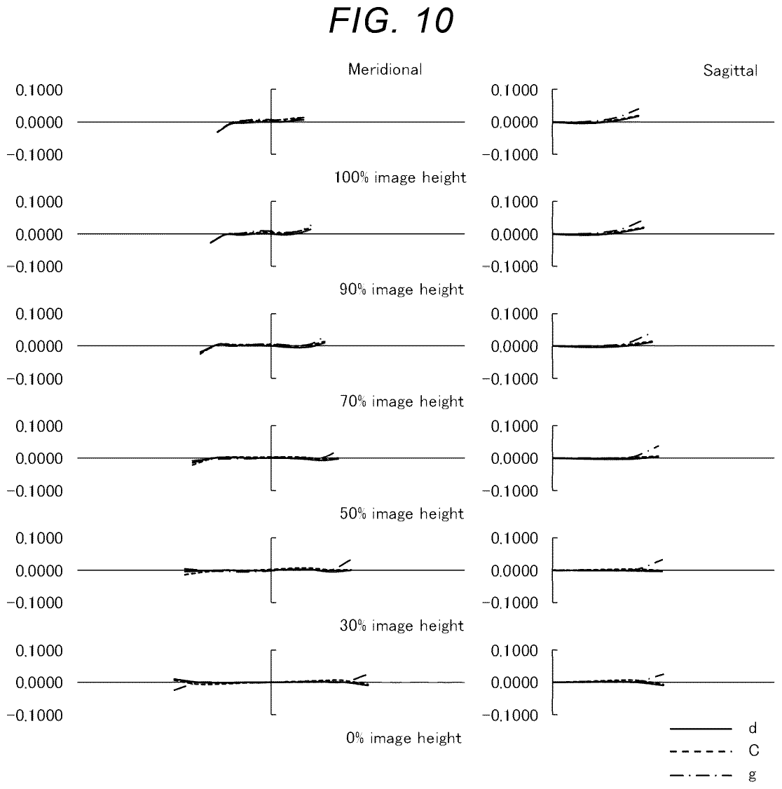

FIG. 11 is a lens configuration diagram according to Example 3 of the imaging optical system of the present invention.

FIG. 12 is a longitudinal aberration diagram of the imaging optical system of Example 3 at infinity focusing.

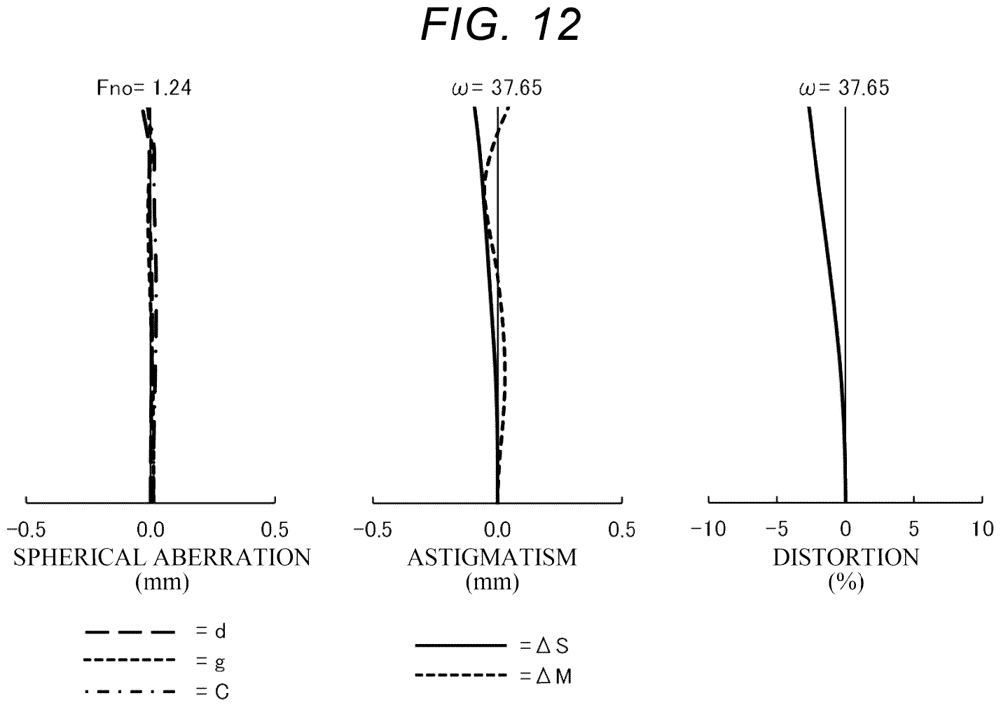

FIG. 13 is a longitudinal aberration diagram at a focusing distance of 1260 mm of the imaging optical system of Example 3.

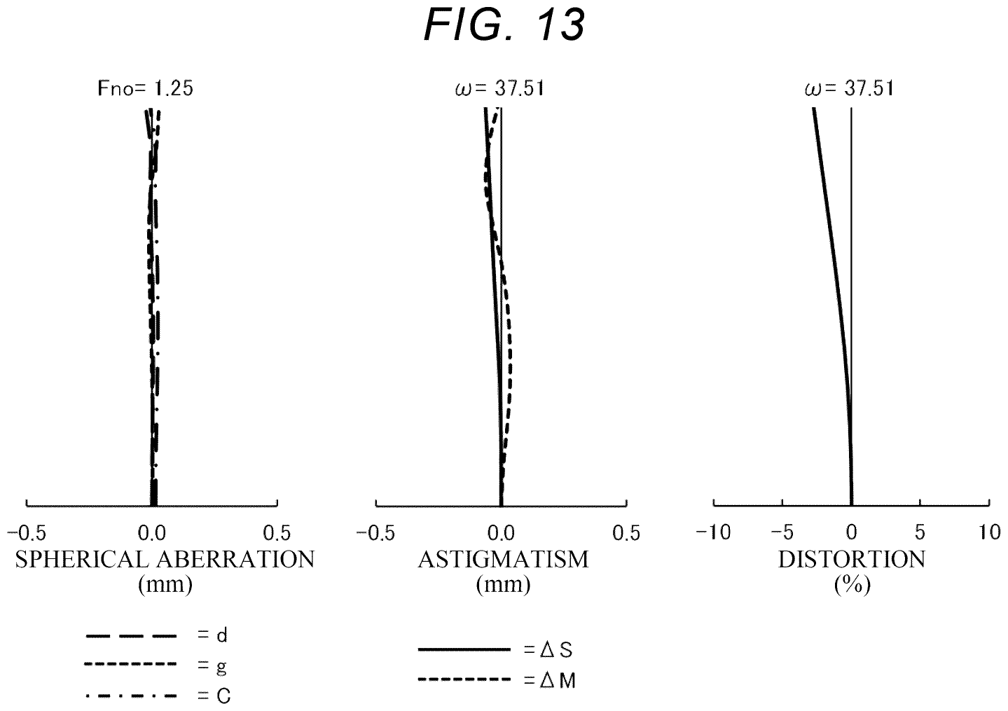

FIG. 14 is a lateral aberration diagram of the imaging optical system of Example 3 at infinity focusing.

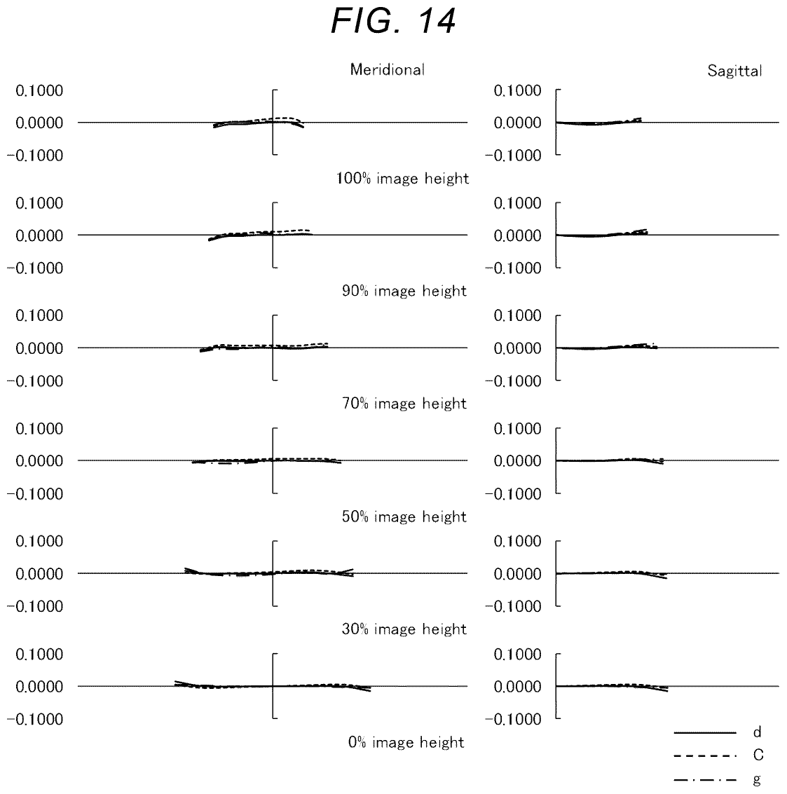

FIG. 15 is a lateral aberration diagram at a focusing distance of 1260 mm in the imaging optical system of Example 3.

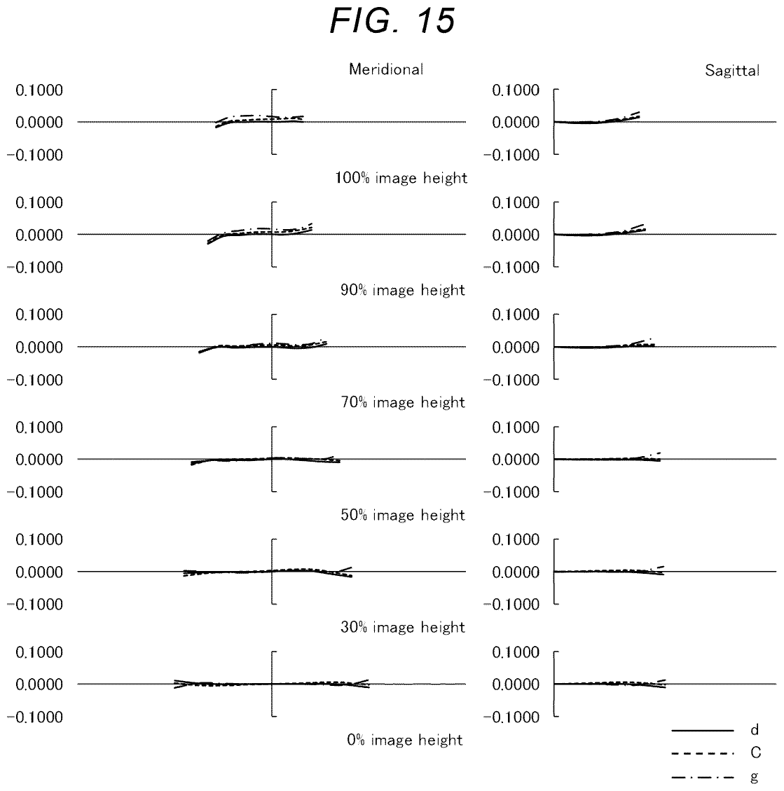

FIG. 16 is a lens configuration diagram according to Example 4 of the imaging optical system of the present invention.

FIG. 17 is a longitudinal aberration diagram of the imaging optical system of Example 4 at infinity focusing.

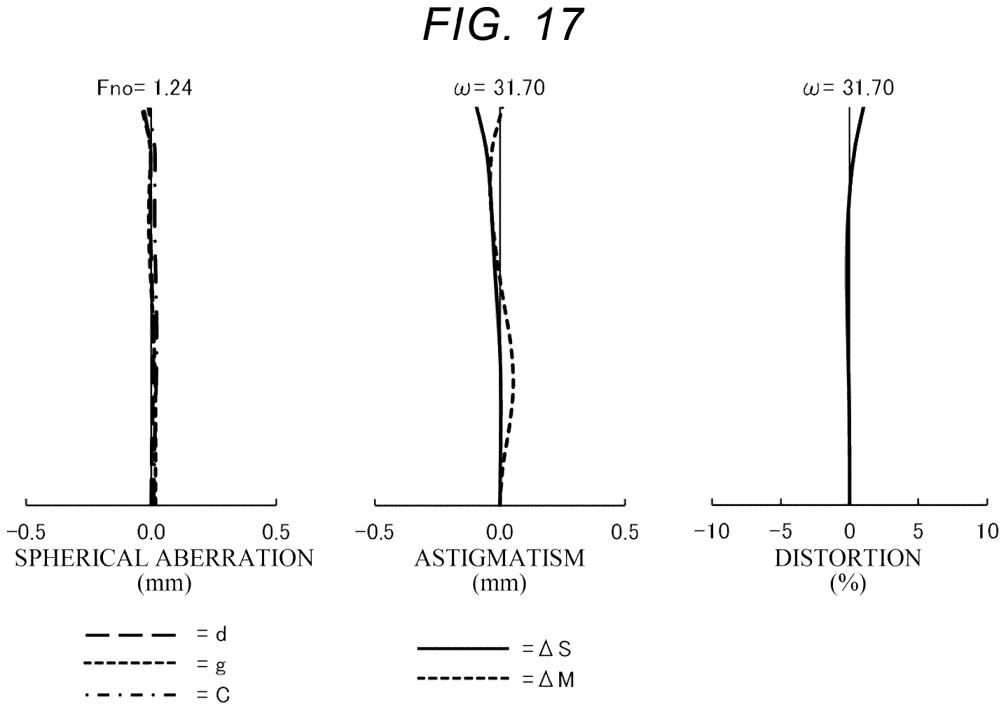

FIG. 18 is a longitudinal aberration diagram at a focusing distance of 1478 mm of the imaging optical system of Example 4.

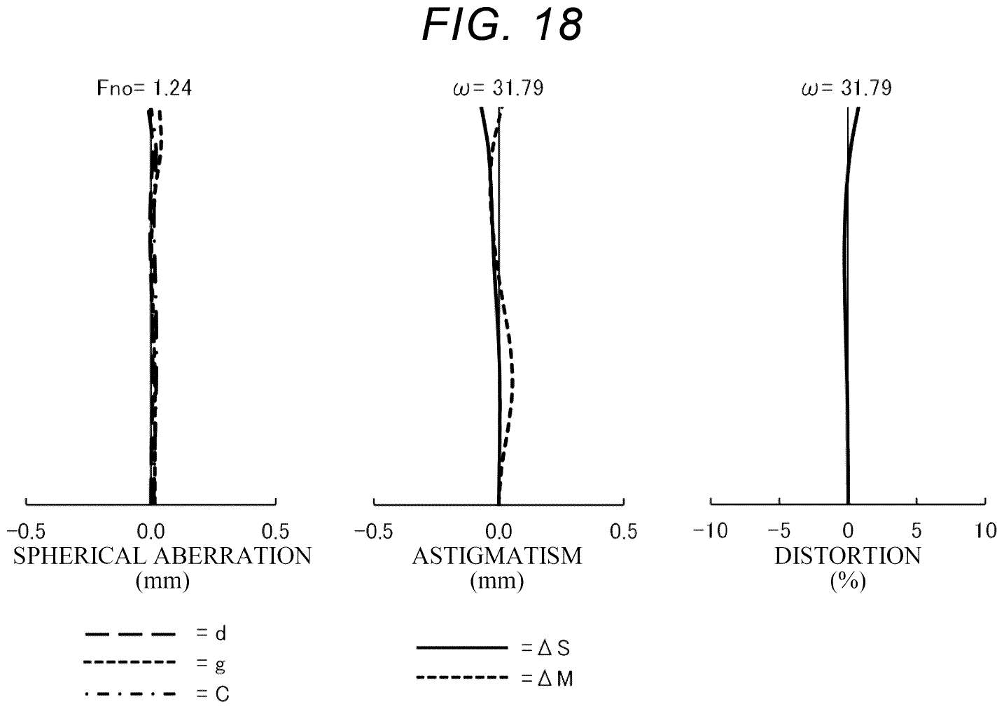

FIG. 19 is a lateral aberration diagram of the imaging optical system of Example 4 at infinity focusing.

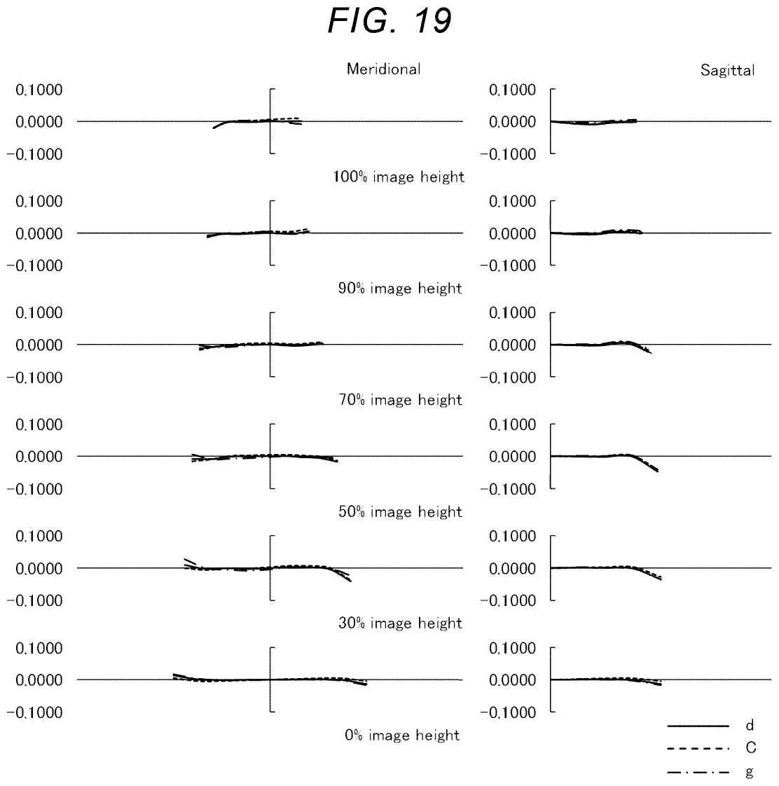

FIG. 20 is a lateral aberration diagram at a focusing distance of 1478 mm of the imaging optical system of Example 4.

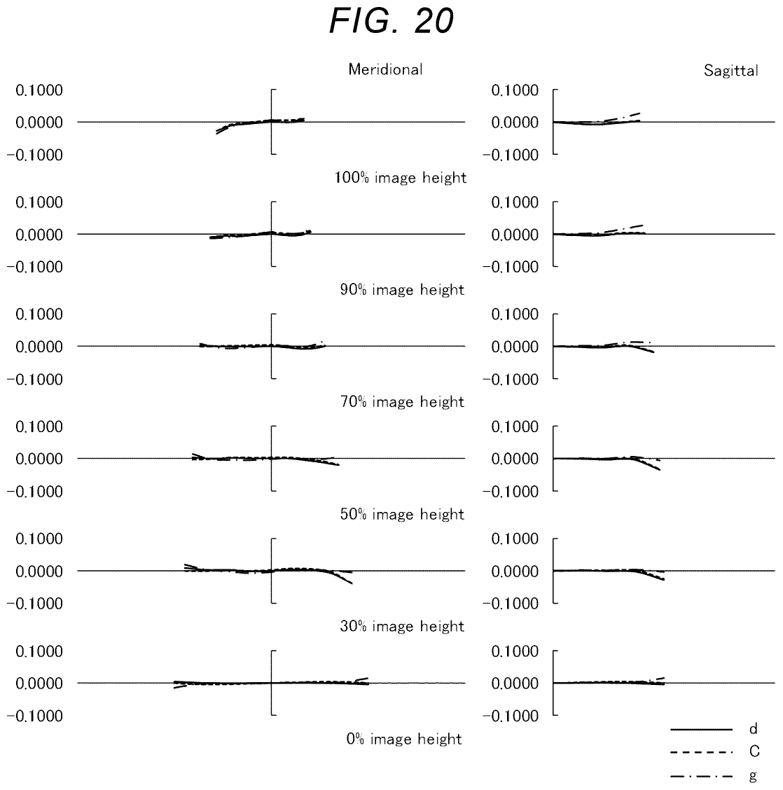

FIG. 21 is a lens configuration diagram according to Example 5 of the imaging optical system of the present invention.

FIG. 22 is a longitudinal aberration diagram of the imaging optical system of Example 5 at infinity focusing.

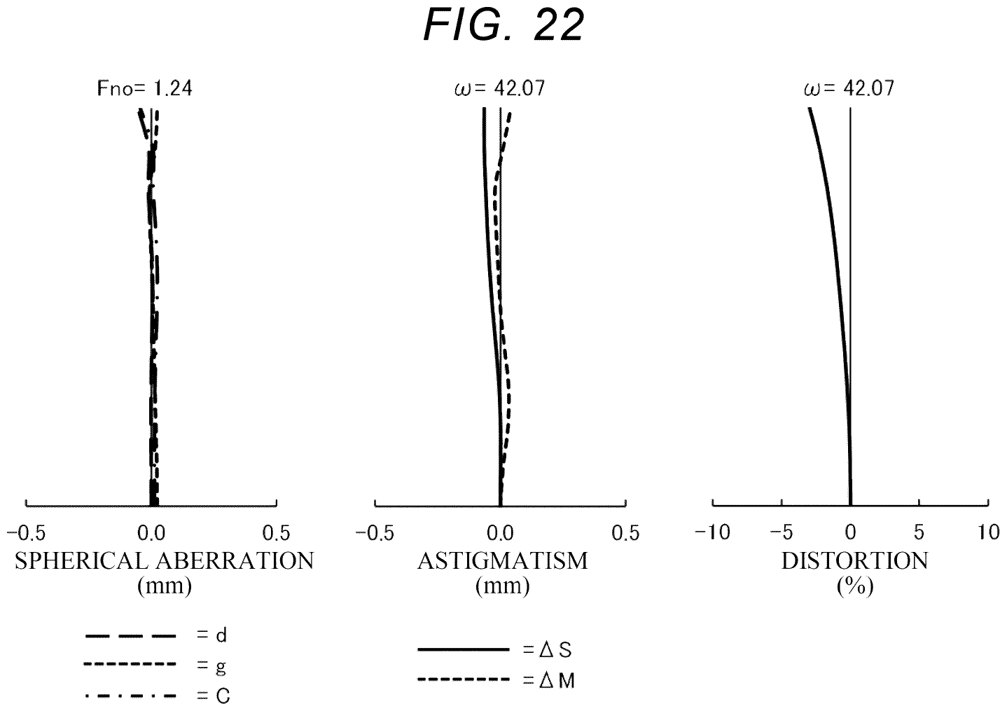

FIG. 23 is a longitudinal aberration diagram at a focusing distance of 1098 mm of the imaging optical system of Example 5.

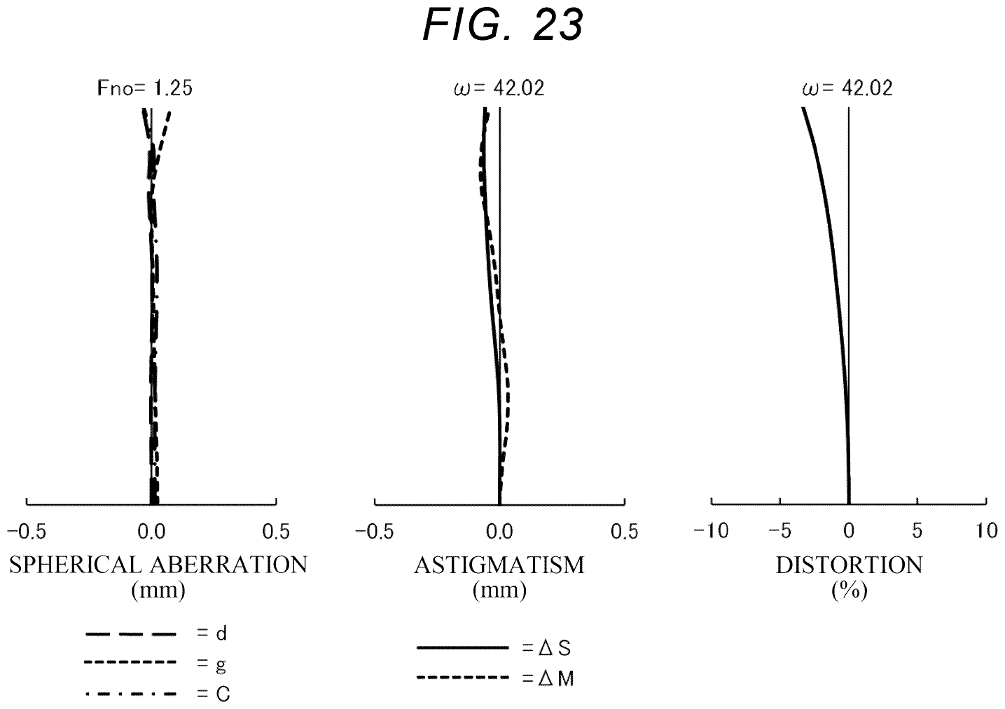

FIG. 24 is a lateral aberration diagram at infinity focusing in the imaging optical system of Example 5.

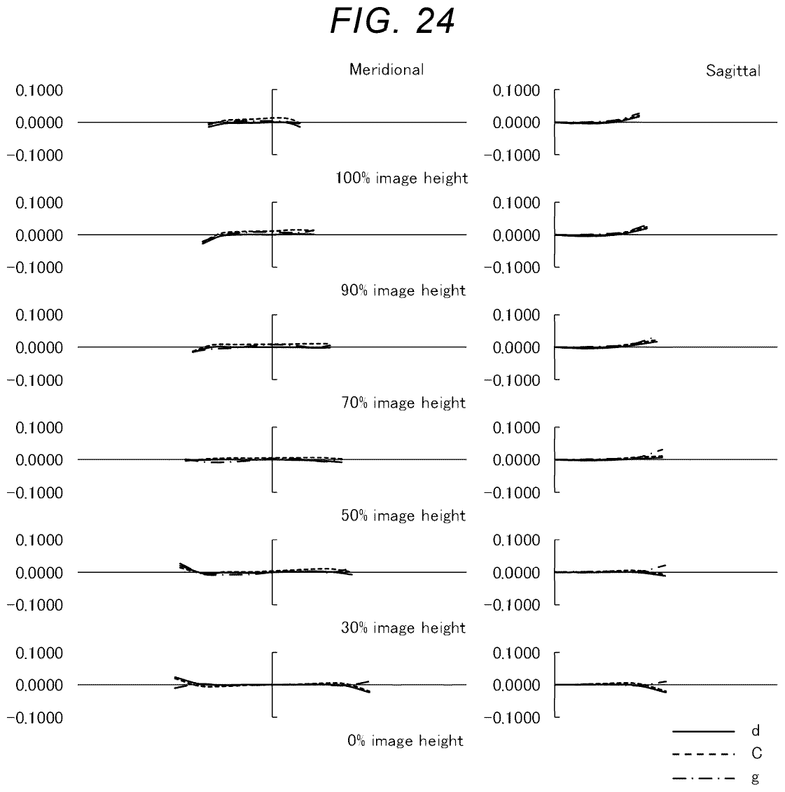

FIG. 25 is a lateral aberration diagram at a focusing distance of 1098 mm of the imaging optical system of Example 5.

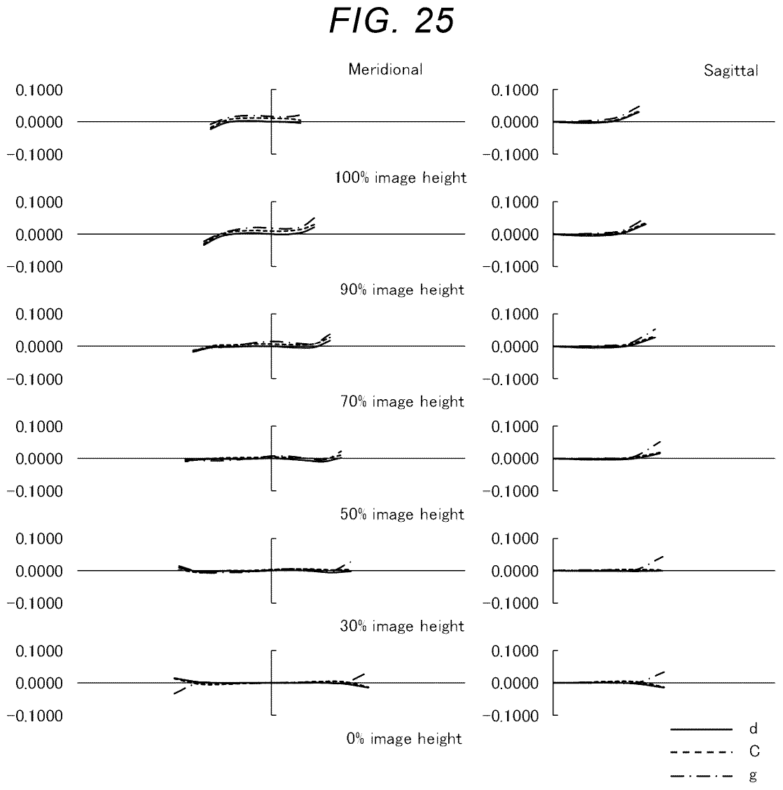

FIG. 26 is a lens configuration diagram according to Example 6 of the imaging optical system of the present invention.

FIG. 27 is a longitudinal aberration diagram of the imaging optical system of Example 6 at infinity focusing.

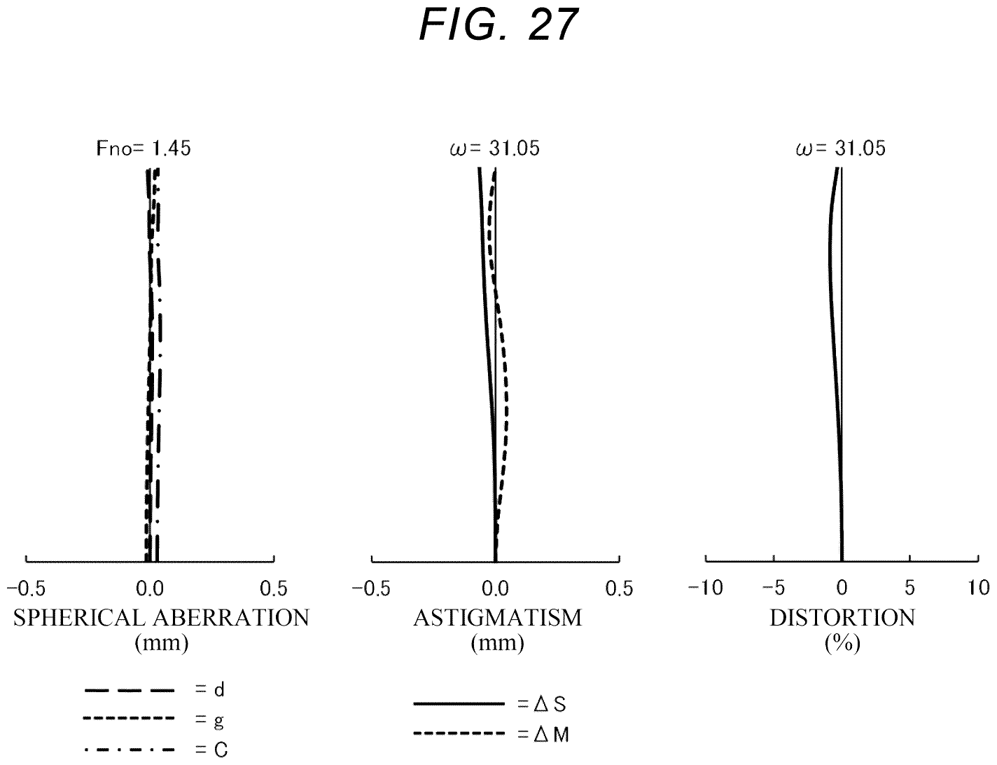

FIG. 28 is a longitudinal aberration diagram of the imaging optical system of Example 6 at a focusing distance of 1529 mm.

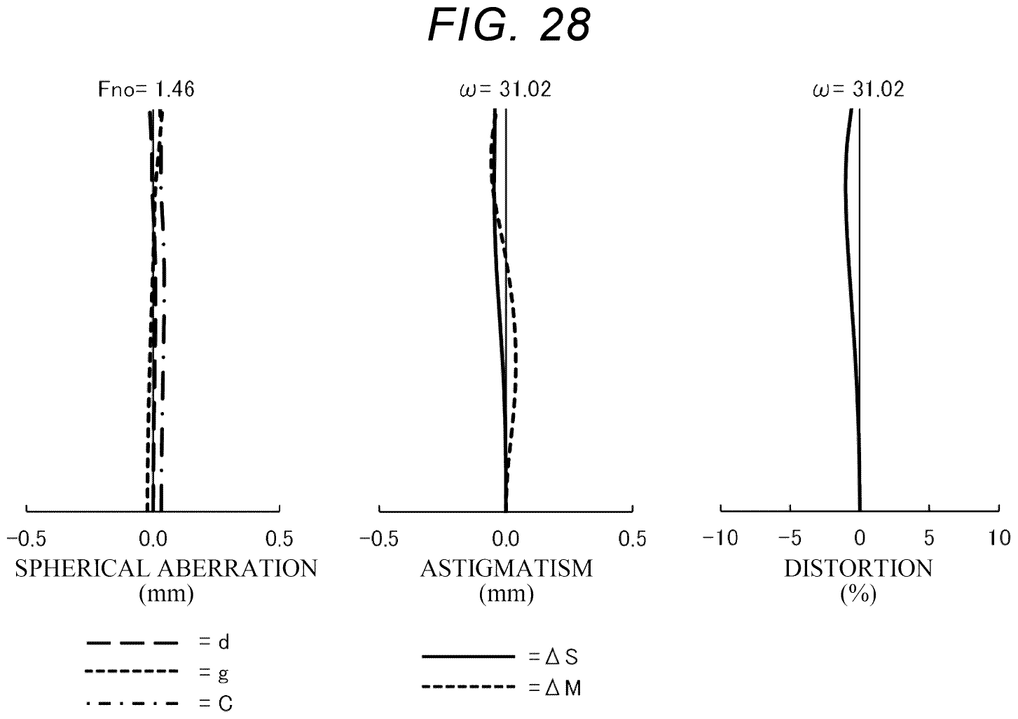

FIG. 29 is a lateral aberration diagram of the imaging optical system of Example 6 at infinity focusing.

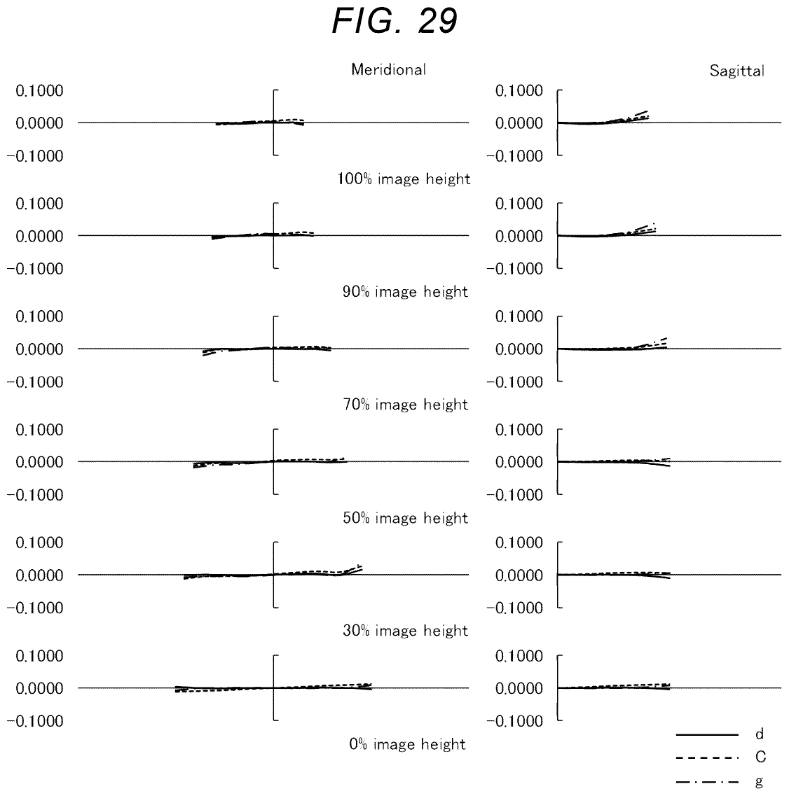

FIG. 30 is a lateral aberration diagram at a focusing distance of 1529 mm in the imaging optical system of Example 6.

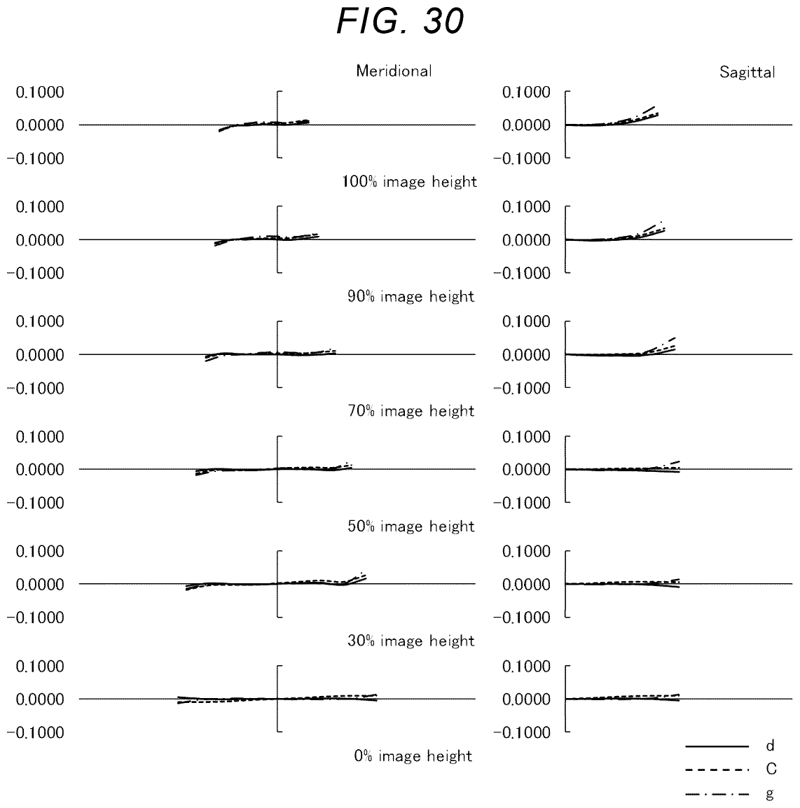

### EMBODIMENTS FOR CARRYING OUT THE INVENTION

Hereinafter, embodiments of the present invention will be described. In a case where refractive indices for a g line (wavelength: 435.8 nm), an F line (wavelength: 486.1 nm), a d line (wavelength: 587.6 nm), and a C line (wavelength: 656.3 nm) are respectively denoted by ng, nF, nd, and nC, an Abbe number νd and a partial dispersion ratio θgF are represented by the following expressions. νd=(nd−1)/(nF−nC)

$$θ gF = ( ng - nF ) / ( nF - nC )$$

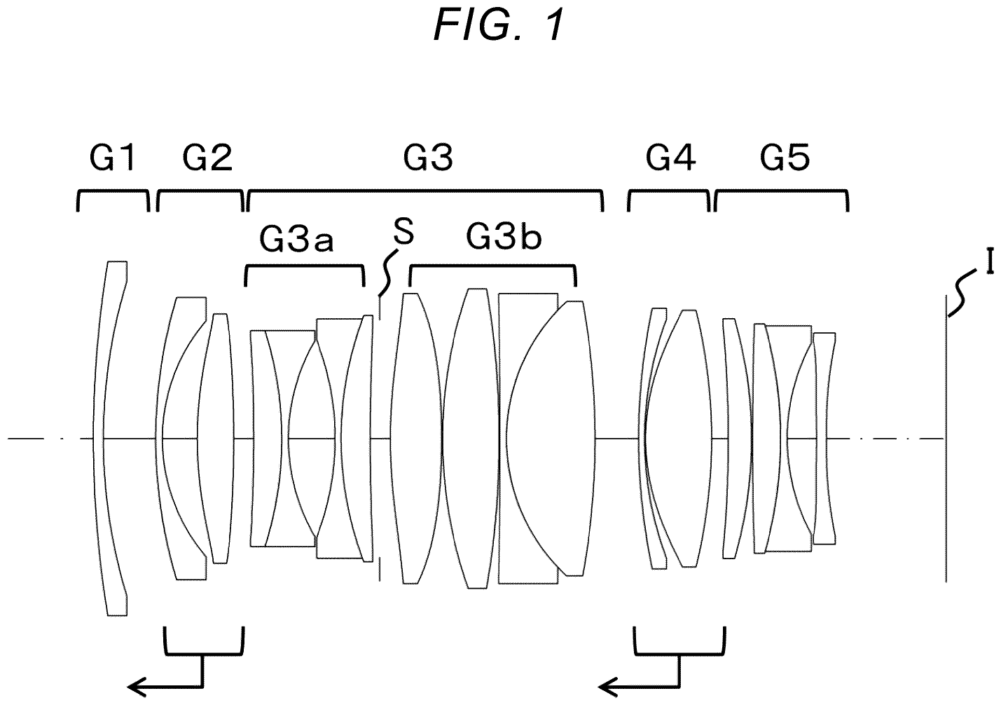

As can be seen from the lens configuration diagrams shown in FIGS. 1, 6, 11, 16, 21, and 26, the imaging optical system of the present invention includes a first lens group G1, a second lens group G2, a third lens group G3 having a positive refractive power, a fourth lens group G4 having a positive refractive power, and a fifth lens group G5 having a negative refractive power in order from the object side, and has a configuration in which, in a case where focusing on the close distance object from the infinite distance object is performed, the first lens group G1 remains stationary with respect to the image surface, the second lens group G2 moves to the object side along the optical axis, the third lens group G3 remains stationary with respect to the image surface, the fourth lens group G4 moves to the object side along the optical axis, the fifth lens group G5 remains stationary with respect to the image surface, and an aperture diaphragm S is provided between the lens surface in the second lens group G2 closest to the image side and the lens surface in the fourth lens group G4 closest to the object side.

In a lens configuration in which the fourth lens group G4 having a positive refractive power, which is disposed closer to the image surface side than the aperture diaphragm S during focusing from the infinite distance object to the close distance object, is extended to the object side along the optical axis, it is easy to suppress the focus breathing by disposing the fourth lens group G4 at a position away from the aperture diaphragm S. On the other hand, in a case where the ray height of the peripheral principal ray is increased, the fluctuation of aberration during focusing, particularly, the fluctuation of astigmatism and comatic aberration increases. In a case where the number of lenses is increased in order to suppress the fluctuation in aberration, the size of the entire optical system is increased.

Therefore, by extending the second lens group G2 disposed closer to the object side than the aperture diaphragm S to the object side along the optical axis in addition to the fourth lens group G4 during focusing from the infinite distance object to the close distance object to offset the fluctuation in aberration during focusing, it is easy to achieve both the suppression of fluctuation in aberration during focusing and the suppression of focus breathing while reducing the size of the entire optical system.

In addition, since the first lens group G1 positioned closest to the object side and the fifth lens group G5 positioned closest to the image side in the optical system are stationary with respect to the image surface during focusing, and a structure in which lenses that move during focusing are not exposed to the outside is adopted, it is easy to improve dustproof and waterproof performance. Since the fifth lens group G5 has a negative refractive power, the position of the exit pupil can be brought closer to the image surface side, and it is easy to suppress the amount of vignetting of peripheral rays due to the constraint of the mount diameter of the camera.

Furthermore, the imaging optical system of the present invention satisfies the conditional expression below.

$$0.3 < D 24 / LT < 0.65 \qquad ( 1 )$$

where
D24: a distance from the lens surface in the second lens group G2 closest to the image side to the lens surface in the fourth lens group G4 closest to the object side at infinity focusing
LT: a distance from a lens surface in the entire lens system closest to the object side to the image surface at the infinity focusing

Conditional Expression (1) specifies a preferable range for appropriate disposition of the second lens group G2 and the fourth lens group G4. As described above, in order to suppress the focus breathing, it is desirable that the fourth lens group G4 is disposed at a position appropriately away from the aperture diaphragm S toward the image side, and it is desirable that the second lens group G2 is disposed at a position appropriately away from the aperture diaphragm S toward the object side so that the second lens group G2 has a certain degree of height of the peripheral principal ray in order to offset the astigmatism and comatic aberration occurring due to the movement of the fourth lens group G4 during focusing. In order for both the second lens group G2 and the fourth lens group G4 to appropriately keep their distances from the aperture diaphragm S, it is necessary to appropriately set the distance between the second lens group G2 and the fourth lens group G4.

In a case where the distance between the second lens group G2 and the fourth lens group G4 is decreased below the lower limit value of Conditional Expression (1), it is difficult to achieve both the suppression of the focus breathing and the suppression of the fluctuation in aberration during focusing. On the other hand, in a case where the distance between the second lens group G2 and the fourth lens group G4 increases beyond the upper limit value of Conditional Expression (1), it is difficult to dispose the first lens group G1 and the fifth lens group G5 fixed during focusing, or the fourth lens group G4 is disposed at a position where the radial constraint near the mount is severe, and it is difficult to dispose the focus actuator.

Regarding Conditional Expression (1), the above-described effect can be made more reliable by desirably limiting the lower limit value to 0.35 and the upper limit value to 0.60.

Furthermore, in the imaging optical system of the present invention, the fifth lens group G5 includes at least one positive lens. By having the positive lens, it is easy to suppress chromatic aberration occurring in the fifth lens group G5 having a negative refractive power.

In addition, it is desirable to satisfy the conditional expressions shown below.

$$θ gF min 5 p - 0.6483 + 0.0018 \times vd min 5 p > 0.025 \qquad ( 2 )$$

$$vd min 5 p < 24. \qquad ( 3 )$$

where
θgFmin5p: partial dispersion ratio of positive lens having minimum Abbe number among positive lenses of the fifth lens group G5 to g line and F line
νdmin5p: Abbe number of positive lens having minimum Abbe number among positive lenses of the fifth lens group G5 with respect to d line

Conditional Expressions (2) and (3) specify preferable characteristics for satisfactorily correcting chromatic aberration including a second spectrum for the material of at least one positive lens included in the fifth lens group G5. Since the fifth lens group G5 is disposed at a position close to the image surface, the ray height of the peripheral principal ray is high, and the on-axis luminous flux diameter is also large in the imaging optical system having a large aperture ratio. Therefore, the lenses in the fifth lens group G5 contribute to the correction of both the lateral chromatic aberration and the on-axis chromatic aberration.

In order to satisfactorily correct chromatic aberration including a secondary spectrum, it is desirable to use a material having high anomalous dispersion (having a large partial dispersion ratio compared to a normal material) for a positive lens. The optical glass that actually exists as a material having particularly high anomalous dispersion is roughly classified into glass having a low refractive index and low dispersion and glass having a high refractive index and high dispersion. The fifth lens group G5 has a negative refractive power. In a case where a material having a low refractive index and low dispersion is used for the positive lens, the primary color correction in the fifth lens group G5 is insufficient. Therefore, it is preferable to select a material having a high refractive index and high dispersion. In addition, by using a material having a high refractive index for the positive lens, it is also easy to suppress the Petzval sum of the entire lens system and to satisfactorily correct the astigmatism.

In a case where the anomalous dispersion of at least one positive lens included in the fifth lens group G5 is decreased below the lower limit value of Conditional Expression (2), it is difficult to satisfactorily correct the longitudinal chromatic aberration and the lateral chromatic aberration including the secondary spectrum.

In Conditional Expression (2), desirably, by limiting the lower limit value to 0.0300, the above-described effect can be made more reliable.

In a case where the Abbe number of at least one positive lens included in the fifth lens increases beyond the upper limit value of Conditional Expression (3), the optical glass satisfying Conditional Expression (2) is limited to the optical glass in a low refractive index and low dispersion region at the present time, the first-order color correction in the fifth lens group G5 is insufficient, and it is difficult to suppress the Petzval sum of the entire lens system and satisfactorily correct the astigmatism.

In Conditional Expression (3), by desirably limiting the upper limit value to 20.50, the above-described effect can be made more reliable.

Furthermore, in the imaging optical system of the present invention, the fifth lens group G5 includes at least two positive lenses. In a case where only one positive lens that satisfies Conditional Expressions (2) and (3) is provided in the fifth lens group G5, the balance of chromatic aberration is largely changed by slightly changing the power of the positive lens because the Abbe number is small. Therefore, the degree of freedom of correction of various aberrations such as spherical aberration other than chromatic aberration is low. Therefore, by disposing a positive lens in addition to the positive lens satisfying Conditional Expressions (2) and (3) in the fifth lens group G5, it is easy to achieve both correction of chromatic aberration and correction of other aberrations.

In addition, the following conditional expressions are satisfied.

$$vd max 5 p - vd min 5 p > 15. \qquad ( 4 )$$

where
νdmax5p: Abbe number of a positive lens having maximum Abbe number with respect to d line among at least two positive lenses included in the fifth lens group G5
νdmin5p: Abbe number of a positive lens having minimum Abbe number among at least two positive lenses of the fifth lens group G5 with respect to d line

Conditional Expression (4) is for specifying a preferable range of a difference in an Abbe number between a positive lens having a maximum Abbe number and a positive lens having a minimum Abbe number among at least two positive lenses of the fifth lens group G5.

In a case where the difference in the Abbe number between the positive lens having the maximum Abbe number and the positive lens having the minimum Abbe number decreases below the lower limit value of Conditional Expression (4), the Abbe numbers of all the positive lenses in the fifth lens group G5 are decreased in conjunction with Conditional Expression (3), and the degrees of freedom of correction of chromatic aberration and other various aberrations are decreased, which makes it difficult to achieve favorable aberration correction.

In Conditional Expression (4), the effect described above can be made more reliable by desirably limiting the lower limit value thereof to 20.00.

Furthermore, in the imaging optical system of the present invention, the fourth lens group G4 consists of one or two positive lenses and one negative lens. The fourth lens group G4 has a positive refractive power. However, by disposing a negative lens and suppressing chromatic aberration in the fourth lens group G4, it is easy to suppress fluctuation in chromatic aberration during focusing.

In a case where the number of lenses of the focus lens group is large and the weight is large, there is a disadvantage in the speedup of auto focus and the quietness during focus driving, and a large actuator is required, making it difficult to reduce the size and weight of the imaging lens. Therefore, it is desirable that the positive lens consists of one or two positive lenses and the negative lens consists of one negative lens.

Furthermore, in the imaging optical system of the present invention, the second lens group G2 and the fourth lens group G4 move to the object side along optical axes on different trajectories during focusing from the infinite distance object to the close distance object. By increasing the degree of freedom of the movement amounts of the second lens group G2 and the fourth lens group G4, it is easier to suppress the fluctuation in various aberrations during focusing.

Furthermore, the imaging optical system of the present invention satisfies the conditional expression below.

$$0.5 < ( 1 - β4 \hat{} 2 ) \times β4 R \hat{} 2 < 2.5 \qquad ( 5 )$$

$$\vert ( ( 1 - β2 \hat{} 2 ) \times β2 R \hat{} 2 ) / ( ( 1 - β4 \hat{} 2 ) \times β4 R \hat{} 2 ) \vert < 0.5 \qquad ( 6 )$$

where
ß4: lateral magnification of the fourth lens group G4 at infinity focusing
ß4R: lateral magnification of lens system positioned closer to the image side than the fourth lens group G4 at infinity focusing
ß2: lateral magnification of the second lens group G2 at infinity focusing
ß2R: lateral magnification of the lens system positioned closer to the image side than the second lens group G2 at infinity focusing

The fourth lens group G4 having a positive refractive power, which is disposed closer to the image side than the aperture diaphragm S, is responsible for most of the focusing action, and thus, it is easy to suppress focus breathing during focusing. Therefore, it is preferable that the focus sensitivity of the second lens group G2 is set to a value smaller than that of the fourth lens group G4 after the focus sensitivity of the fourth lens group G4 is appropriately set. Conditional Expression (5) specifies a preferable range of the focus sensitivity of the fourth lens group G4.

In a case where the focus sensitivity of the fourth lens group G4 is decreased below the lower limit value of Conditional Expression (5), the amount of movement required to satisfy the desired shortest focusing distance increases, and it is difficult to reduce the size and weight of the imaging lens due to an increase in the total length of the lens for securing the movement space or an increase in the size of the actuator. On the other hand, in a case where the focus sensitivity of the fourth lens group G4 is increased beyond the upper limit value of Conditional Expression (5), the positive refractive power of the fourth lens group G4 is increased, and the eccentricity sensitivity of the fourth lens group G4 is increased, that is, the amount of deterioration in performance in a case of being eccentric is increased. The fourth lens group G4 is likely to be eccentric in order to be driven during focusing, and in a case where the eccentricity sensitivity of the fourth lens group G4 exceeds the upper limit and becomes large, it is difficult to suppress the individual variation in the image formation performance of the imaging lens.

In Conditional Expression (5), by desirably limiting the lower limit value to 0.65 and the upper limit value to 2.00, the above-described effect can be made more reliable.

Conditional Expression (6) specifies a preferable range for a ratio between the focus sensitivity of the second lens group G2 and the focus sensitivity of the fourth lens group G4.

In a case where the ratio of the focus sensitivity of the second lens group G2 is increased beyond the upper limit value of Conditional Expression (6), it is difficult to sufficiently suppress focus breathing during focusing.

In Conditional Expression (6), desirably, by limiting the upper limit value to 0.40, the above-described effect can be made more reliable.

Furthermore, in the imaging optical system of the present invention, the third lens group G3 includes at least two positive lenses and at least two negative lenses. By increasing the number of positive lenses and negative lenses in the third lens group G3 in which the on-axis luminous flux diameter increases in the vicinity of the aperture diaphragm S, it is easy to satisfactorily correct various aberrations, particularly, longitudinal chromatic aberration, spherical aberration, and comatic aberration even in the imaging optical system having a large aperture ratio.

In addition, the following conditional expressions are satisfied.

$$vd max 3 p - vd min 3 p > 30. \qquad ( 7 )$$

$$θ gF max 3 p - 0.6483 + 0.0018 \times vd max 3 p > 0.012 \qquad ( 8 )$$

$$θ gF min 3 p - 0.6483 + 0.0018 \times vd min 3 p > 0.02 \qquad ( 9 )$$

where
νdmax3p: Abbe number of a positive lens having maximum Abbe number among at least two positive lenses of the third lens group G3 with respect to d line
νdmin3p: Abbe number of a positive lens having minimum Abbe number among at least two positive lenses included in the third lens group G3 with respect to d line
θgFmax3p: partial dispersion ratio of a positive lens having maximum Abbe number among at least two positive lenses of the third lens group G3 with respect to g line and F line
θgFmin3p: partial dispersion ratio of a positive lens having minimum Abbe number among at least two positive lenses of the third lens group G3 with respect to g line and F line

In order to satisfactorily correct chromatic aberration including a secondary spectrum, it is desirable to use a material having high anomalous dispersion (having a large partial dispersion ratio compared to a normal material) for a positive lens. In particular, by using a material having high anomalous dispersion for the positive lens in the vicinity of the diaphragm, it is easy to satisfactorily correct longitudinal chromatic aberration. The optical glasses that actually exist as materials having particularly high anomalous dispersions are roughly classified into glasses having low refractive indexes and low dispersions and glasses having high refractive indexes and high dispersions.

In a case where materials having low refractive indexes and low dispersions are used for all the positive lenses of the third lens group G3, it is necessary to increase the curvature of the positive lens in order to obtain a required positive refractive power, and it is difficult to reduce the size and weight of the imaging lens due to an increase in the total length and weight of the lens system. In addition, the Petzval sum increases, and it is difficult to suppress the astigmatism. On the other hand, in a case where materials having high refractive indexes and high dispersions are used for all the positive lenses of the third lens group G3, chromatic aberration occurring in the third lens group G3 increases, and it is difficult to satisfactorily correct chromatic aberration in the entire lens system.

Accordingly, it is desirable to have both a positive lens formed of a material having a low refractive index, low dispersion, and high anomalous dispersion and a positive lens formed of a material having a high refractive index, high dispersion, and high anomalous dispersion. Conditional Expression (7) specifies a preferable range for a difference in Abbe number between a positive lens having a maximum Abbe number and a positive lens having a minimum Abbe number, which are included in the third lens group G3.

In a case where the difference in the Abbe number between the positive lens having the maximum Abbe number and the positive lens having the minimum Abbe number in the third lens group G3 is smaller than the lower limit value of Conditional Expression (7), it is difficult to have both a positive lens formed of a material having a low refractive index, low dispersion, and high anomalous dispersion and a positive lens formed of a material having a high refractive index, high dispersion, and high anomalous dispersion in the currently existing optical glass, and it is difficult to achieve both favorable correction of chromatic aberration including a second-order spectrum, favorable correction of various aberrations other than chromatic aberration, and reduction in size and weight of the imaging lens.

In Conditional Expression (7), desirably, by limiting the lower limit value to 35.00, the above-described effect can be made more reliable.

Conditional Expression (8) specifies a preferable range for the anomalous dispersion of the positive lens having the maximum Abbe number in the third lens group G3.

In a case where the anomalous dispersion of the positive lens having the maximum Abbe number of the third lens group G3 decreases below the lower limit value of Conditional Expression (8), it is difficult to satisfactorily correct the chromatic aberration, particularly the longitudinal chromatic aberration, including the second spectrum.

In Conditional Expression (8), desirably, by limiting the lower limit value thereof to 0.0150, the above-described effect can be made more reliable.

Conditional Expression (9) specifies a preferable range for the anomalous dispersion of the positive lens having the minimum Abbe number in the third lens group G3.

In a case where the anomalous dispersion of the positive lens having the maximum Abbe number of the third lens group G3 is decreased below the lower limit value of Conditional Expression (9), it is difficult to satisfactorily correct chromatic aberration, particularly longitudinal chromatic aberration, including the second-order spectrum.

In Conditional Expression (9), desirably, by limiting the lower limit value to 0.0250, the above-described effect can be made more reliable.

Furthermore, the imaging optical system of the present invention satisfies the conditional expression below.

$$D 2 S / LT > 0.06 \qquad ( 10 )$$

$$D 4 S / LT > 0.15 \qquad ( 11 )$$

where
D2S: distance from lens surface closest to the image side in the second lens group G2 to the aperture diaphragm S at infinity focusing
D4S: distance from lens surface closest to the object side in the fourth lens group G4 to the aperture diaphragm S at infinity focusing
LT: a distance from a lens surface of the entire lens system closest to the object side to the image surface at the infinity focusing

Conditional Expression (10) specifies a preferable range for appropriate disposition of the second lens group G2 and the aperture diaphragm S. It is desirable that the second lens group G2 is disposed at a position appropriately separated from the aperture diaphragm S toward the object side so that the second lens group G2 has a certain degree of height of the peripheral principal ray in order to offset astigmatism and comatic aberration generated by movement of the fourth lens group G4 during focusing.

In a case where the distance between the second lens group G2 and the aperture diaphragm S decreases below the lower limit value of Conditional Expression (10), it is difficult to suppress fluctuations in various aberrations, particularly fluctuations in astigmatism and comatic aberration, during focusing.

In Conditional Expression (10), desirably, by limiting the lower limit value to 0.10, the above-described effect can be made more reliable.

Conditional Expression (11) specifies a preferable range for appropriate disposition of the fourth lens group G4 and the aperture diaphragm S. As described above, in order to suppress the focus breathing, it is desirable that the fourth lens group G4 is disposed at a position appropriately away from the aperture diaphragm S toward the image side.

In a case where the distance between the fourth lens group G4 and the aperture diaphragm S is decreased below the lower limit value of Conditional Expression (11), it is difficult to suppress focus breathing.

In Conditional Expression (11), by desirably limiting the lower limit value to 0.20, the above-described effect can be made more reliable.

Furthermore, in the imaging optical system of the present invention, the third lens group G3 includes a third a lens group G3a having a negative refractive power, an aperture diaphragm S, and a third b lens group G3b having a positive refractive power in order from the object side. In order to satisfactorily correct spherical aberration or comatic aberration in the imaging optical system with a large aperture ratio, it is preferable to once increase the F-number luminous flux diameter and then converge the luminous flux diameter toward the image surface. On the other hand, in order to reduce the weight of the second lens group G2 and the fourth lens group G4 that are driven during focusing, it is preferable that the F-number ray diameter in the second lens group G2 and the fourth lens group G4 is small. In order to achieve both of these, it is desirable to adopt a configuration in which a negative refractive power is disposed on the object side and a positive refractive power is disposed on the image side in the third lens group G3, and the F number ray diameter is once diverged in the third lens group G3 and then converged toward the fourth lens group G4.

In addition, the negative refractive power of the third a lens group G3a causes the position of the incident pupil to move to the object side, and the ray height of the peripheral rays in the first lens group G1 and the second lens group G2 is reduced and the lens diameter is lowered. As a result, it is easy to reduce the size and weight of the imaging lens. In addition, the exit pupil position is moved to the object side by the positive refractive power of the third b lens group G3b, the ray incident angle of the peripheral principal ray incident on the image surface is reduced, and it is easy to keep the ray incident angle allowable range of the image sensor. In addition, since the angle between the optical axis and the peripheral principal ray incident on the fourth lens group G4 is reduced by the positive refractive power of the third b lens group G3b, it is easy to suppress focus breathing during focusing.

In addition, the following conditional expressions are satisfied.

$$- 3. < f 3 a / f < - 0.50 \qquad ( 12 )$$

$$0.5 < f 3 b / f < 3.00 \qquad ( 13 )$$

where
f: focal length of the entire lens system at infinity focusing
f3a: focal length of the third a lens group G3a
f3b: focal length of the third b lens group G3b

Conditional Expression (12) specifies a preferable range for a ratio of the focal length of the third a lens group G3a to the focal length of the entire lens system.

In a case where the negative refractive power of the third a lens group G3a is weakened below the lower limit value of Conditional Expression (12), the F number rays cannot be sufficiently spread in the third lens group G3, and it is difficult to satisfactorily correct various aberrations, particularly, spherical aberration or comatic aberration. In addition, in a case where the negative refractive power of the third a lens group G3a is weak, the position of the incident pupil of the entire lens system is moved to the image side, and in a case where the peripheral illumination is to be maintained, the lens diameters of the first lens group G1 and the second lens group G2 are increased, and it is difficult to reduce the size and weight of the imaging lens.

On the other hand, in a case where the negative refractive power of the third a lens group G3a is increased beyond the upper limit value of Conditional Expression (12), the positive refractive power of the third b lens group G3b is increased in order to maintain the refractive power of the entire third lens group G3, and the eccentricity sensitivity of the third a lens group G3a and the third b lens group G3b is increased. As a result, it is difficult to suppress the individual variation in the image formation performance of the imaging lens. In addition, in a case where the negative refractive power of the third a lens group G3a is increased, the position of the incident pupil of the entire lens system is moved to the object side, the peripheral principal ray height in the second lens group G2 is decreased, and it is difficult to offset and suppress the fluctuation of the various aberrations generated in the fourth lens group G4 during focusing.

In Conditional Expression (12), by desirably limiting the lower limit value to −2.00 and the upper limit value to −0.70, the above-described effect can be made more reliable.

Conditional Expression (13) specifies a preferable range for a ratio of the focal length of the third b lens group G3b to the focal length of the entire lens system.

In a case where the positive refractive power of the third b lens group G3b increases and the value of Conditional Expression (13) decreases below the lower limit value, the negative refractive power of the third a lens group G3a increases in order to maintain the refractive power of the entire third lens group G3, and the eccentricity sensitivity of the third a lens group G3a and the third b lens group G3b increases. As a result, it is difficult to suppress the individual variation in the image formation performance of the imaging lens. In addition, in a case where the positive refractive power of the third b lens group G3b increases, the position of the exit pupil of the entire lens system moves to the object side, and in a case where the peripheral illumination is to be maintained, the lens diameters of the fourth lens group G4 and the fifth lens group G5 increase, making it difficult to reduce the size and weight of the imaging lens.

On the other hand, in a case where the positive refractive power of the third b lens group G3b is weakened and the value of Conditional Expression (13) is beyond the upper limit value, the F number rays cannot be sufficiently converged toward the fourth lens group G4, the lens diameter of the fourth lens group G4 increases, and it is difficult to reduce the size and weight of the imaging lens. In addition, in a case where the positive refractive power of the third b lens group G3b is weak, the position of the exit pupil of the entire lens system is moved to the image side, the ray incident angle on the image surface is increased, and it is difficult to keep the ray incident angle allowable range of the image sensor. In addition, the angle between the peripheral principal ray incident into the fourth lens group G4 and the optical axis increases, and it is difficult to suppress focus breathing during focusing.

In Conditional Expression (13), by desirably limiting the lower limit value to 0.70 and the upper limit value to 2.00, the above-described effect can be made more reliable.

In the imaging optical system of the present invention, it is more preferable to further include the following configuration.

By introducing the aspherical surfaces into the second lens group G2 and the fourth lens group G4, it is easier to suppress fluctuation in spherical aberration, comatic aberration, and field curvature during focusing.

By introducing the aspherical surface into the third lens group G3, it is easier to suppress various aberrations, particularly spherical aberration and comatic aberration.

By introducing an aspherical surface having a shape that increases a negative refractive power from the center of optical axis to the periphery in the fifth lens group G5, it is easier to suppress various aberrations, particularly astigmatism.

By disposing two or more sets of cemented lenses in the third lens group G3, it is easier to suppress various aberrations, particularly longitudinal chromatic aberration, while suppressing eccentricity sensitivity.

Next, lens configurations of examples according to the imaging optical system of the present invention will be described. In the following description, the lens configuration will be described in order from the object side to the image side.

### Example 1

FIG. 1 is a lens configuration diagram of an imaging optical system of Example 1 of the present invention.

The imaging optical system includes, in order from the object side, a first lens group G1 having a negative refractive power, a second lens group G2 having a positive refractive power, a third lens group G3 having a positive refractive power, a fourth lens group G4 having a positive refractive power, and a fifth lens group G5 having a negative refractive power, and has a configuration in which, in a case where focusing is performed from an infinite distance object to a close distance object, the second lens group G2 is moved to the object side along the optical axis, and the fourth lens group G4 is moved to the object side along the optical axis.

The first lens group G1 includes a negative meniscus lens having a convex surface toward the object side.

The second lens group G2 includes a negative meniscus lens having a convex surface toward the object side and a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes: a cemented lens including a positive meniscus lens having a convex surface toward the image side, and a biconcave lens; and a cemented lens including a biconcave lens, and a positive meniscus lens having a convex surface toward the object side. The third b lens group G3b includes: a biconvex lens; a biconvex lens; and a cemented lens including a biconcave lens and a biconvex lens. The object side surface and the image side surface of the biconvex lens disposed on the object side have predetermined aspherical surface shapes.

The fourth lens group G4 consists of a negative meniscus lens having a convex surface toward the object side and a biconvex lens. The object side surface and the image side surface of the biconvex lens have predetermined aspherical surface shapes.

The fifth lens group G5 includes a positive meniscus lens having a convex surface toward the image side, a cemented lens including a biconvex lens and a biconcave lens, and a biconcave lens. The object side surface and the image side surface of the biconcave lens disposed on the image side have predetermined aspherical surface shapes.

### Example 2

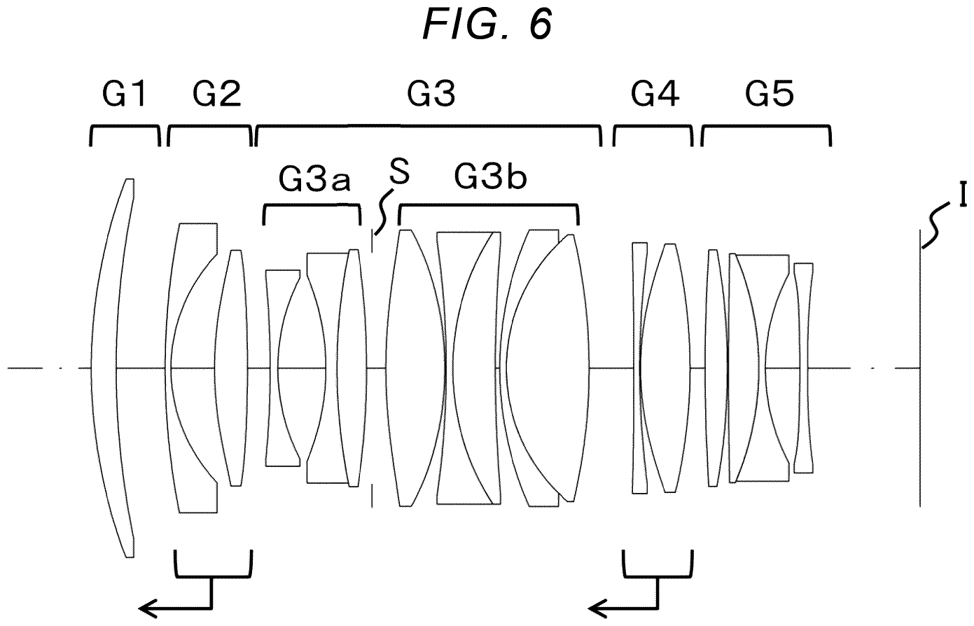

FIG. 6 is a lens configuration diagram of an imaging optical system of Example 2 of the present invention.

The imaging optical system includes, in order from the object side, a first lens group G1 having a positive refractive power, a second lens group G2 having a positive refractive power, a third lens group G3 having a positive refractive power, a fourth lens group G4 having a positive refractive power, and a fifth lens group G5 having a negative refractive power, and has a configuration in which, in a case where focusing on a close distance object from an infinite distance object is performed, the second lens group G2 is moved to the object side along the optical axis, and the fourth lens group G4 is moved to the object side along the optical axis.

The first lens group G1 includes a positive meniscus lens having a convex surface toward the object side.

The second lens group G2 includes a negative meniscus lens having a convex surface toward the object side and a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes a biconcave lens and a cemented lens including a biconcave lens and a biconvex lens. The third b lens group G3b includes: a biconvex lens; a cemented lens including a biconcave lens, and a positive meniscus lens having a convex surface toward the object side; and a cemented lens including a negative meniscus lens, and a biconvex lens having a convex surface toward the object side. The object side surface and the image side surface of the biconvex lens disposed on the object side have predetermined aspherical surface shapes.

The fourth lens group G4 consists of a biconcave lens and a biconvex lens. The object side surface and the image side surface of the biconvex lens have predetermined aspherical surface shapes.

The fifth lens group G5 includes a biconvex lens, a cemented lens including a biconvex lens and a biconcave lens, and a biconcave lens. The object side surface and the image side surface of the biconcave lens disposed on the image side have predetermined aspherical surface shapes.

### Example 3

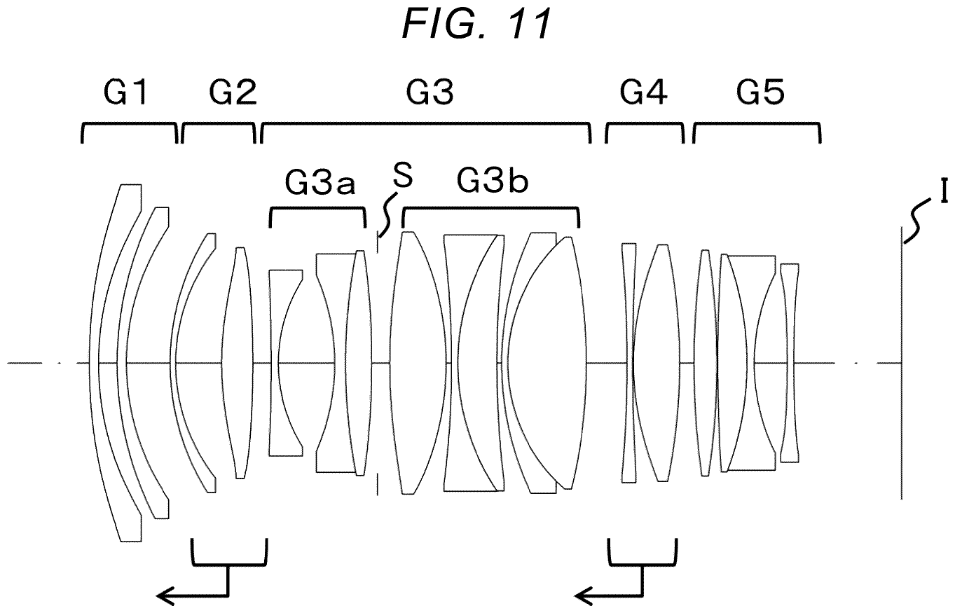

FIG. 11 is a lens configuration diagram of the imaging optical system of Example 3 of the present invention.

The imaging optical system includes, in order from the object side, a first lens group G1 having a negative refractive power, a second lens group G2 having a positive refractive power, a third lens group G3 having a positive refractive power, a fourth lens group G4 having a positive refractive power, and a fifth lens group G5 having a negative refractive power, and has a configuration in which, in a case where focusing is performed from an infinite distance object to a close distance object, the second lens group G2 is moved to the object side along the optical axis, and the fourth lens group G4 is moved to the object side along the optical axis.

The first lens group G1 includes a negative meniscus lens having a convex surface toward the object side and a negative meniscus lens having a convex surface toward the object side. An object side surface and an image side surface of a negative meniscus lens disposed on the object side have predetermined aspherical surface shapes.

The second lens group G2 includes a negative meniscus lens having a convex surface toward the object side and a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes a biconcave lens and a cemented lens including a biconcave lens and a biconvex lens. The third b lens group G3b includes: a biconvex lens; a cemented lens including a biconcave lens, and a positive meniscus lens having a convex surface toward the object side; and a cemented lens including a negative meniscus lens having a convex surface toward the object side, and a biconvex lens. The object side surface and the image side surface of the biconvex lens disposed on the object side have predetermined aspherical surface shapes.

The fourth lens group G4 consists of a biconcave lens and a biconvex lens. The object side surface and the image side surface of the biconvex lens have predetermined aspherical surface shapes.

The fifth lens group G5 includes a biconvex lens, a cemented lens including a biconvex lens and a biconcave lens, and a biconcave lens. The object side surface and the image side surface of the biconcave lens disposed on the image side have predetermined aspherical surface shapes.

### Example 4

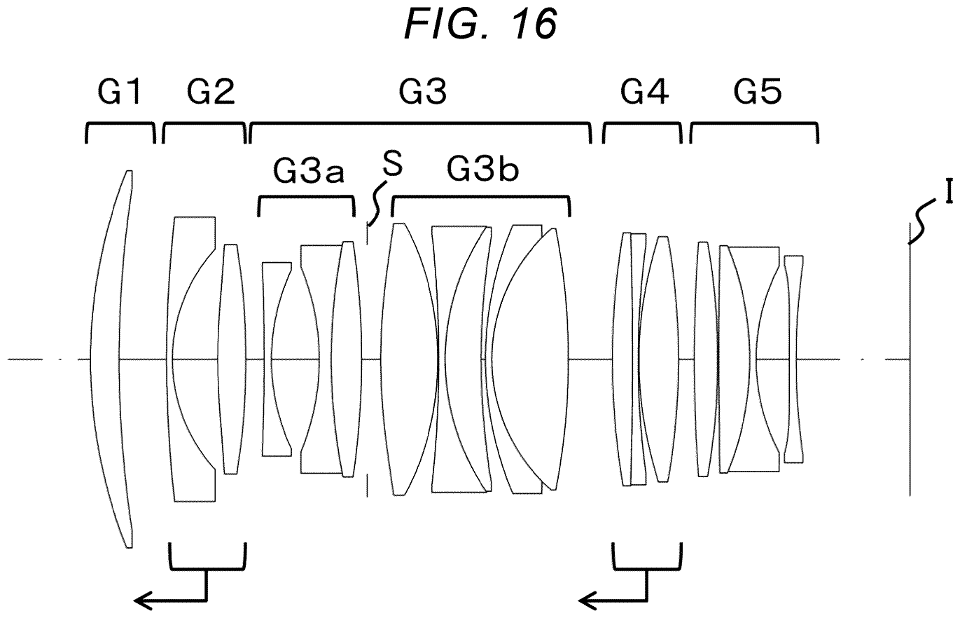

FIG. 16 is a lens configuration diagram of an imaging optical system of Example 4 of the present invention.

The imaging optical system includes, in order from the object side, a first lens group G1 having a positive refractive power, a second lens group G2 having a negative refractive power, a third lens group G3 having a positive refractive power, a fourth lens group G4 having a positive refractive power, and a fifth lens group G5 having a negative refractive power, and has a configuration in which, in a case where focusing on a close distance object from an infinite distance object is performed, the second lens group G2 is moved to the object side along the optical axis, and the fourth lens group G4 is moved to the object side along the optical axis.

The first lens group G1 includes a positive meniscus lens having a convex surface toward the object side.

The second lens group G2 includes a negative meniscus lens having a convex surface toward the object side and a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes a biconcave lens, and a cemented lens including a biconcave lens and a biconvex lens. The third b lens group G3b includes: a biconvex lens; a cemented lens including a biconcave lens and a positive meniscus lens having a convex surface toward the object side; and a cemented lens including a negative meniscus lens having a convex surface toward the object side, and a biconvex lens. The object side surface and the image side surface of the biconvex lens disposed on the object side have predetermined aspherical surface shapes.

The fourth lens group G4 consists of: a cemented lens including a biconvex lens and a biconcave lens; and a biconvex lens. The object side surface and the image side surface of the biconvex lens disposed on the image side have predetermined aspherical surface shapes.

The fifth lens group G5 includes a biconvex lens, a cemented lens including a biconvex lens and a biconcave lens, and a biconcave lens. The object side surface and the image side surface of the biconcave lens disposed on the image side have predetermined aspherical surface shapes.

### Example 5

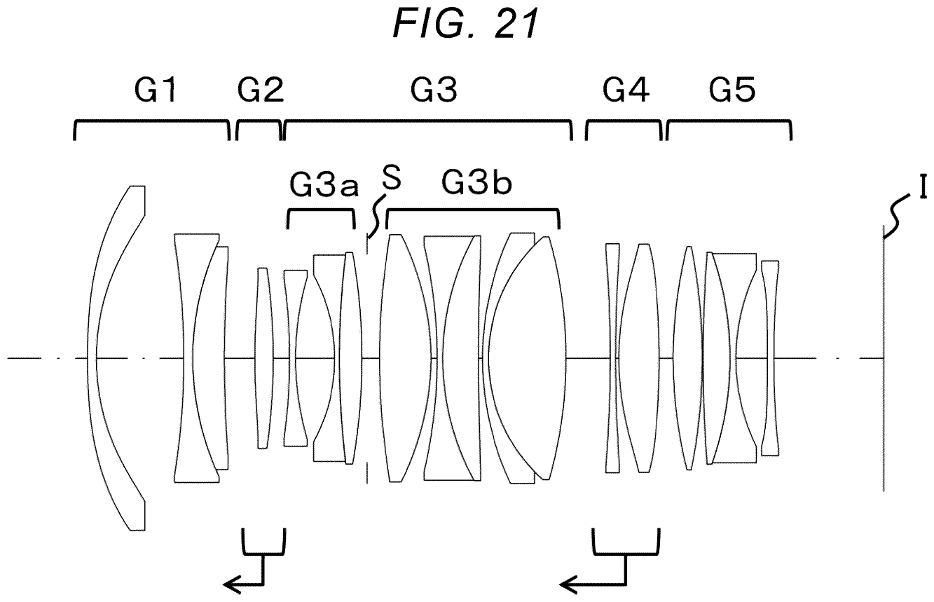

FIG. 21 is a lens configuration diagram of an imaging optical system of Example 5 of the present invention.

The imaging optical system includes, in order from the object side, a first lens group G1 having a negative refractive power, a second lens group G2 having a positive refractive power, a third lens group G3 having a positive refractive power, a fourth lens group G4 having a positive refractive power, and a fifth lens group G5 having a negative refractive power, and has a configuration in which, in a case where focusing is performed from an infinite distance object to a close distance object, the second lens group G2 is moved to the object side along the optical axis, and the fourth lens group G4 is moved to the object side along the optical axis.

The first lens group G1 includes a cemented lens including a negative meniscus lens convex surface toward the object side, a biconcave lens, and a positive meniscus lens convex surface toward the object side. The object side surface and the image side surface of the negative meniscus lens have predetermined aspherical surface shapes.

The second lens group G2 includes a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes a biconcave lens, and a cemented lens including a biconcave lens and a biconvex lens. The third b lens group G3b includes: a biconvex lens; a cemented lens including a biconcave lens, and a positive meniscus lens having a convex surface toward the object side; and a cemented lens including a negative meniscus lens having a convex surface toward the object side, and a biconvex lens. The object side surface and the image side surface of the biconvex lens disposed on the object side have predetermined aspherical surface shapes.

The fourth lens group G4 consists of a biconcave lens and a biconvex lens. The object side surface and the image side surface of the biconvex lens have predetermined aspherical surface shapes.

The fifth lens group G5 includes a biconvex lens, a cemented lens including a biconvex lens and a biconcave lens, and a biconcave lens. The object side surface and the image side surface of the biconcave lens disposed on the image side have predetermined aspherical surface shapes.

### Example 6

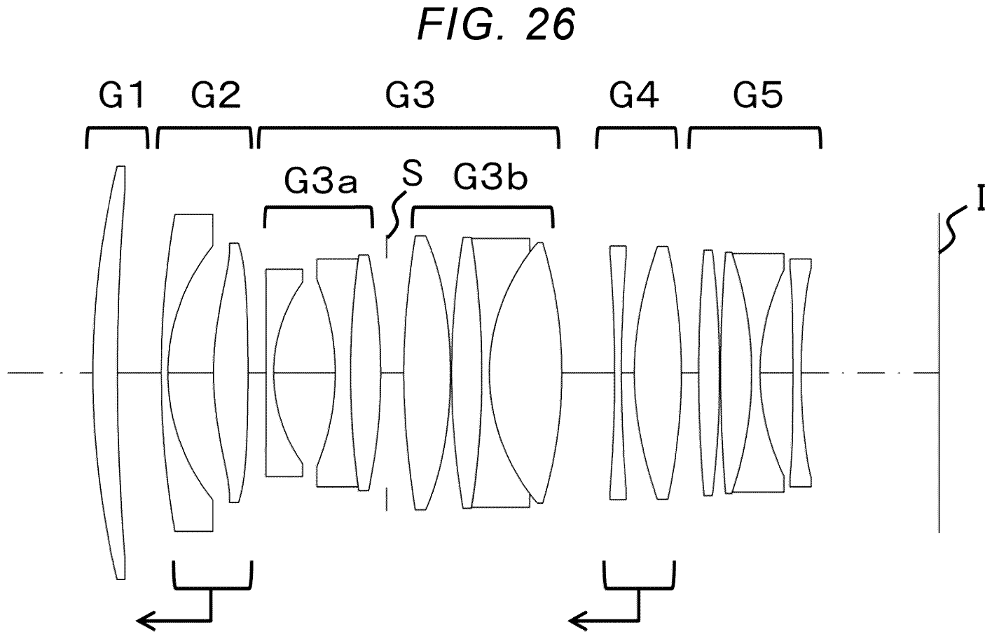

FIG. 26 is a lens configuration diagram of an imaging optical system of Example 6 of the present invention.

The imaging optical system includes, in order from the object side, a first lens group G1 having a positive refractive power, a second lens group G2 having a positive refractive power, a third lens group G3 having a positive refractive power, a fourth lens group G4 having a positive refractive power, and a fifth lens group G5 having a negative refractive power, and has a configuration in which, in a case where focusing on a close distance object from an infinite distance object is performed, the second lens group G2 is moved to the object side along the optical axis, and the fourth lens group G4 is moved to the object side along the optical axis.

The first lens group G1 includes a positive meniscus lens having a convex surface toward the object side.

The second lens group G2 includes a negative meniscus lens having a convex surface toward the object side and a biconvex lens. The object side surface and the image side surface of the biconvex lens have predetermined aspherical surface shapes.

The third lens group G3 includes a third a lens group G3a having a negative refractive power, an aperture diaphragm S, and a third b lens group G3b having a positive refractive power. The third a lens group G3a includes a biconcave lens and a cemented lens including a biconcave lens and a biconvex lens. The third b lens group G3b includes: a biconvex lens; and a triplet cemented lens including a biconvex lens, a biconcave lens, and a biconvex lens. The object side surface and the image side surface of the biconvex lens disposed on the object side have predetermined aspherical surface shapes.

The fourth lens group G4 consists of a biconcave lens and a biconvex lens. The object side surface and the image side surface of the biconvex lens have predetermined aspherical surface shapes.

The fifth lens group G5 includes: a biconvex lens; a cemented lens including a biconvex lens and a biconcave lens; and a biconcave lens. The object side surface and the image side surface of the biconcave lens disposed on the image side have predetermined aspherical surface shapes.

Specific numerical data of each example of the imaging optical system of the present invention will be shown below.

In [Surface data], the surface number is a number of a lens surface or an aperture diaphragm counted from the object side, r is a curvature radius of each surface, d is a distance between the surfaces, nd is a refractive index with respect to the d line (587.6 nm), νd is an Abbe number with respect to the d line, and θgF is a partial dispersion ratio.

An asterisk (*) attached to a surface number indicates that the lens surface shape is an aspherical surface shape. In addition, BF represents a back focus.

The (diaphragm) attached to the surface number indicates that the aperture diaphragm is located at that position. In a case of a curvature radius with respect to a plane or an aperture diaphragm, ∞ (infinity) is written.

[Aspherical surface data] shows each coefficient value for giving the aspherical surface shape of the lens surface marked with * in [Surface data]. In a case where a displacement from the optical axis in a direction perpendicular to the optical axis is y, a displacement (sag) from an intersection of the optical axis and the aspherical surface in an optical axis direction is z, a curvature radius of a reference spherical surface is r, a conic coefficient is K, and aspherical coefficients of respective orders are A4, A6, A8, . . . , the shape of the aspherical surface shall be such that the coordinates of the aspherical surface are represented by the following expression.

$$z = \frac{( 1 / r ) {y}^{2}}{1 + \sqrt{1 - ( 1 + K ) {( y / r )}^{2}}} + A 4 {y}^{4} + A 6 {y}^{6} + A 8 {y}^{8} + A 10 {y}^{10} + A 12 {y}^{12}$$

[Various types of data] indicate values such as a focal length in each focusing distance focusing state.

The [Variable distance data] shows the variable distance and the BF value in each focusing distance-focusing state.

The [Lens group data] shows the surface number closest to the object side in each lens group and the total focal length of the entire group.

In addition, in the values of all the specifications described below, unless otherwise noted, the units of the focal length f, the curvature radius r, the lens surface distance d, and other lengths are millimeters (mm), but the present invention is not limited thereto since the same optical performance can be obtained in both the proportional magnification and the proportional reduction in the optical system. In addition, a list of corresponding values of the conditional expressions in each of these examples is shown.

In addition, in the aberration diagrams corresponding to the respective examples, d, g, and C represent a d line, a g line, and a C line, respectively, and ΔS and ΔM represent a sagittal image surface and a meridional image surface, respectively.

### Numerical Example 1

Unit: mm
[Surface data]

| Surface number | r | d | nd | vd | θgF |
|---|---|---|---|---|---|
| Object plane | ∞ | (d0) | | | |
| 1 | 167.6789 | 1.5000 | 1.48749 | 70.44 | 0.5306 |
| 2 | 82.1737 | (d2) | | | |
| 3 | 74.6020 | 1.0000 | 1.51680 | 64.20 | 0.5343 |
| 4 | 27.5648 | 5.2807 | | | |
| 5* | 60.0819 | 5.5743 | 1.77377 | 47.17 | 0.5557 |
| 6* | −175.7567 | (d6) | | | |
| 7 | −253.3953 | 4.2381 | 2.00100 | 29.13 | 0.5995 |
| 8 | −53.8752 | 1.0000 | 1.48749 | 70.44 | 0.5306 |
| 9 | 29.6674 | 7.1121 | | | |
| 10 | −40.8245 | 0.9000 | 1.73037 | 32.23 | 0.5899 |
| 11 | 52.5872 | 4.4152 | 1.86966 | 20.02 | 0.6435 |
| 12 | 400.9216 | 1.4150 | | | |
| 13 (diaphragm) | ∞ | 1.6234 | | | |
| 14* | 80.2928 | 7.7904 | 1.77377 | 47.17 | 0.5557 |
| 15* | −104.3501 | 0.1500 | | | |
| 16 | 68.2204 | 8.5345 | 1.72916 | 54.67 | 0.5453 |
| 17 | −137.1949 | 0.1500 | | | |
| 18 | −1015.0352 | 1.0000 | 1.85478 | 24.80 | 0.6122 |
| 19 | 28.3858 | 13.4407 | 1.59282 | 68.62 | 0.5440 |
| 20 | −113.2611 | (d20) | | | |
| 21 | 96.0501 | 0.9000 | 1.78880 | 28.43 | 0.6009 |
| 22 | 51.6996 | 0.1500 | | | |
| 23* | 32.2560 | 10.0050 | 1.76450 | 49.09 | 0.5528 |
| 24* | −72.8148 | (d24) | | | |
| 25 | −184.7089 | 3.5090 | 1.59282 | 68.62 | 0.5440 |
| 26 | −65.5065 | 0.1500 | | | |
| 27 | 542.8836 | 4.2916 | 1.98612 | 16.48 | 0.6656 |
| 28 | −62.8269 | 1.0000 | 1.73037 | 32.23 | 0.5899 |
| 29 | 30.7717 | 4.4908 | | | |
| 30* | −200.0000 | 1.4934 | 1.85135 | 40.10 | 0.5695 |
| 31* | 300.0000 | (BF) | | | |
| image surface | ∞ | | | | |

[Aspherical surface data]

| | 5 surfaces | 6 surfaces | 14 surfaces | 15 surfaces | 23 surfaces |
|---|---|---|---|---|---|
| K | 0.00000 | 0.00000 | 0.00000 | 0.00000 | 0.00000 |
| A4 | −2.03707E−06 | 9.15268E−07 | −3.80694E−06 | −4.53933E−06 | −5.05513E−06 |
| A6 | −2.14268E−09 | −3.73451E−10 | −4.82319E−09 | −2.18530E−09 | −2.41545E−10 |
| A8 | −7.96874E−12 | −1.37775E−11 | 6.78481E−12 | 0.00000E+00 | −1.50502E−11 |
| A10 | −1.89790E−14 | 0.00000E+00 | −2.44617E−15 | 0.00000E+00 | 8.76725E−15 |
| A12 | 0.00000E+00 | 0.00000E+00 | 0.00000E+00 | 0.00000E+00 | 0.00000E+00 |

| | 24 surfaces | 30 surfaces | 31 surfaces |
|---|---|---|---|
| K | 0.00000 | 0.00000 | 0.00000 |
| A4 | 4.97489E−06 | 4.89669E−05 | 6.27914E−05 |
| A6 | −9.98378E−09 | −3.89051E−07 | −3.66759E−07 |
| A8 | 4.11965E−12 | 9.02051E−10 | 8.36129E−10 |
| A10 | 0.00000E+00 | −5.64056E−13 | 1.25753E−13 |
| A12 | 0.00000E+00 | 0.00000E+00 | −1.80050E−15 |

[Various types of data]

| | INF | 1462 mm |
|---|---|---|
| Focal length | 33.98 | 33.62 |
| F number | 1.24 | 1.25 |
| Total angle of view 2ω | 65.29 | 65.28 |
| Image height Y | 21.63 | 21.63 |
| Total length of lens | 129.30 | 129.30 |

[Variable distance data]

| | INF | 1462 mm |
|---|---|---|
| d0 | ∞ | 1333.0502 |
| d2 | 7.9666 | 7.4157 |
| d6 | 3.0000 | 3.5509 |
| d20 | 6.6195 | 6.1542 |
| d24 | 2.5000 | 2.9652 |
| BF | 18.0998 | 18.0998 |

[Lens group data]

| Group | Starting surface | Focal length |
|---|---|---|
| G1 | 1 | −332.47 |
| G2 | 3 | 153.57 |
| G3 | 7 | 142.83 |
| G4 | 21 | 38.28 |
| G5 | 25 | −52.80 |
| G3a | 7 | −33.54 |
| G3b | 14 | 37.87 |

### Numerical Example 2

Unit: mm
[Surface data]

| Surface number | r | d | nd | vd | θgF |
|---|---|---|---|---|---|
| Object plane | ∞ | (d0) | | | |
| 1 | 82.3764 | 3.9192 | 1.80809 | 22.76 | 0.6287 |
| 2 | 130.8893 | (d2) | | | |
| 3 | 114.6913 | 0.9000 | 1.54072 | 47.20 | 0.5678 |
| 4 | 25.5542 | 6.8043 | | | |
| 5* | 56.8249 | 5.0982 | 1.80610 | 40.73 | 0.5694 |
| 6* | −211.8812 | (d6) | | | |
| 7 | −148.2676 | 1.1795 | 1.48749 | 70.44 | 0.5306 |
| 8 | 30.6500 | 7.5007 | | | |
| 9 | −36.5540 | 1.7147 | 1.69895 | 30.05 | 0.6028 |
| 10 | 90.4412 | 4.6177 | 1.94594 | 17.98 | 0.6546 |
| 11 | −125.9694 | 0.8682 | | | |
| 12 (diaphragm) | ∞ | 2.1148 | | | |
| 13* | 90.0023 | 9.1378 | 1.77377 | 47.17 | 0.5557 |
| 14* | −48.2139 | 0.2057 | | | |
| 15 | −138.5636 | 1.0225 | 1.78880 | 28.43 | 0.6009 |
| 16 | 38.9207 | 6.5952 | 1.75500 | 52.32 | 0.5473 |
| 17 | 240.3404 | 0.6848 | | | |
| 18 | 52.3045 | 1.0136 | 1.85451 | 25.15 | 0.6103 |
| 19 | 27.2000 | 12.8779 | 1.59282 | 68.62 | 0.5440 |
| 20 | −90.7789 | (d20) | | | |
| 21 | −848.1912 | 0.9000 | 1.69895 | 30.05 | 0.6028 |
| 22 | 138.1440 | 0.1500 | | | |
| 23* | 46.2651 | 7.6904 | 1.76450 | 49.09 | 0.5528 |
| 24* | −76.0969 | (d24) | | | |
| 25 | 296.4918 | 3.4967 | 1.75500 | 52.32 | 0.5473 |
| 26 | −104.4793 | 0.1532 | | | |
| 27 | 820.4806 | 4.6992 | 1.98612 | 16.48 | 0.6656 |
| 28 | −45.0663 | 1.0168 | 1.78880 | 28.43 | 0.6009 |
| 29 | 31.6000 | 5.3461 | | | |
| 30* | −169.2643 | 1.2141 | 1.85135 | 40.10 | 0.5695 |
| 31* | 1000.0000 | (BF) | | | |
| image surface | ∞ | | | | |

[Aspherical surface data]

| | 5 surfaces | 6 surfaces | 13 surfaces | 14 surfaces | 23 surfaces |
|---|---|---|---|---|---|
| K | 0.00000 | 0.00000 | 0.00000 | 0.00000 | 0.00000 |
| A4 | −1.99816E−06 | −4.72277E−07 | −1.03559E−06 | 7.71680E−07 | −1.71933E−06 |
| A6 | −1.32897E−09 | −3.38850E−10 | −1.87709E−09 | −1.40925E−09 | 7.19596E−10 |
| A8 | −2.08157E−11 | −2.11984E−11 | −7.13483E−12 | −8.22545E−12 | −1.65373E−11 |
| A10 | 3.95950E−15 | 2.31760E−14 | 1.19593E−14 | 9.14549E−15 | 1.66871E−14 |
| A12 | 0.00000E+00 | 0.00000E+00 | 0.00000E+00 | 0.00000E+00 | 0.00000E+00 |

| | 24 surfaces | 30 surfaces | 31 surfaces |
|---|---|---|---|
| K | 0.00000 | 0.00000 | 0.00000 |
| A4 | 3.82753E−06 | 2.91423E−05 | 4.31949E−05 |
| A6 | −5.16977E−09 | −2.82416E−07 | −2.72422E−07 |
| A8 | −8.71093E−12 | 6.89447E−10 | 7.46965E−10 |
| A10 | 1.35974E−14 | −5.19770E−13 | −4.31810E−13 |
| A12 | 0.00000E+00 | 0.00000E+00 | −6.05302E−16 |

[Various types of data]

| | INF | 1477 mm |
|---|---|---|
| Focal length | 34.60 | 34.14 |
| F number | 1.24 | 1.24 |
| Total angle of view 2ω | 63.74 | 63.79 |
| Image height Y | 21.63 | 21.63 |
| Total length of lens | 128.74 | 128.74 |

[Variable distance data]

| | INF | 1477 mm |
|---|---|---|
| d0 | ∞ | 1348.7267 |
| d2 | 7.5696 | 7.0438 |
| d6 | 3.5035 | 4.0289 |
| d20 | 6.9518 | 6.3311 |
| d24 | 2.2921 | 2.9132 |
| BF | 17.4972 | 17.4972 |

[Lens group data]

| Group | Starting surface | Focal length |
|---|---|---|
| G1 | 1 | 265.45 |
| G2 | 3 | 280.37 |
| G3 | 7 | 84.37 |
| G4 | 21 | 49.37 |
| G5 | 25 | −68.06 |
| G3a | 7 | −35.31 |
| G3b | 13 | 39.46 |

### Numerical Example 3

Unit: mm
[Surface data]

| Surface number | r | d | nd | vd | θgF |
|---|---|---|---|---|---|
| Object plane | ∞ | (d0) | | | |
| 1* | 94.7921 | 1.5000 | 1.59201 | 67.02 | 0.5358 |
| 2* | 48.6723 | 3.0156 | | | |
| 3 | 55.2220 | 1.5000 | 1.69680 | 55.46 | 0.5426 |
| 4 | 39.2576 | (d4) | | | |
| 5 | 39.7403 | 0.9000 | 1.51823 | 58.96 | 0.5442 |
| 6 | 30.3135 | 7.4857 | | | |
| 7* | 54.3443 | 5.0541 | 1.85135 | 40.10 | 0.5695 |
| 8* | −171.9304 | (d8) | | | |
| 9 | −305.7766 | 1.1491 | 1.48749 | 70.44 | 0.5306 |
| 10 | 25.6370 | 9.1574 | | | |
| 11 | −35.9149 | 1.7577 | 1.69895 | 30.05 | 0.6028 |
| 12 | 97.0893 | 4.2569 | 1.98612 | 16.48 | 0.6656 |
| 13 | −132.2556 | 0.9733 | | | |
| 14 (diaphragm) | ∞ | 2.0076 | | | |
| 15* | 102.0923 | 9.1365 | 1.76802 | 49.24 | 0.5516 |
| 16* | −46.2530 | 0.8805 | | | |
| 17 | −158.2138 | 1.0207 | 1.78880 | 28.43 | 0.6009 |
| 18 | 37.0523 | 6.3876 | 1.75500 | 52.32 | 0.5473 |
| 19 | 162.0452 | 0.7727 | | | |
| 20 | 49.4853 | 1.0025 | 1.85451 | 25.15 | 0.6103 |
| 21 | 27.4275 | 12.7850 | 1.57144 | 71.61 | 0.5419 |
| 22 | −86.9564 | (d22) | | | |
| 23 | −204.2242 | 0.9000 | 1.72825 | 28.32 | 0.6075 |
| 24 | 306.2991 | 0.1500 | | | |
| 25* | 45.7000 | 7.4944 | 1.76802 | 49.24 | 0.5516 |
| 26* | −86.2845 | (d26) | | | |
| 27 | 135.7686 | 3.6953 | 1.80420 | 46.50 | 0.5573 |
| 28 | −124.2184 | 0.1509 | | | |
| 29 | 281.5753 | 4.7389 | 1.98612 | 16.48 | 0.6656 |
| 30 | −50.0937 | 1.1733 | 1.85451 | 25.15 | 0.6103 |
| 31 | 33.1672 | 5.3679 | | | |
| 32* | −161.0607 | 1.1378 | 1.88202 | 37.22 | 0.5770 |
| 33* | 600.5507 | (BF) | | | |
| image surface | ∞ | | | | |

[Aspherical surface data]

| | 1 surfaces | 2 surfaces | 7 surfaces | 8 surfaces | 15 surfaces |
|---|---|---|---|---|---|
| K | 0.00000 | 0.00000 | 0.00000 | 0.00000 | 0.00000 |
| A4 | 2.19188E−06 | 1.42073E−06 | −3.59436E−06 | −1.68468E−07 | 8.01180E−07 |
| A6 | −1.07210E−09 | 7.47233E−11 | −6.23641E−09 | −4.99666E−09 | −2.64253E−09 |
| A8 | −1.02593E−12 | −3.03689E−12 | −6.34003E−12 | −6.69818E−12 | −9.63329E−12 |
| A10 | 2.69264E−16 | 0.00000E+00 | −3.42557E−14 | −1.40147E−14 | 1.32493E−14 |
| A12 | 0.00000E+00 | 0.00000E+00 | 0.00000E+00 | 0.00000E+00 | 0.00000E+00 |

| | 16 surfaces | 25 surfaces | 26 surfaces | 32 surfaces | 33 surfaces |
|---|---|---|---|---|---|
| K | 0.00000 | 0.00000 | 0.00000 | 0.00000 | 0.00000 |
| A4 | 1.90304E−06 | −4.45820E−07 | 4.15630E−06 | 1.74585E−05 | 3.35467E−05 |
| A6 | −2.24204E−09 | −1.62173E−09 | −6.71816E−09 | −2.55742E−07 | −2.46584E−07 |
| A8 | −9.14348E−12 | −1.12051E−11 | −3.43582E−12 | 7.74246E−10 | 8.76116E−10 |
| A10 | 7.88368E−15 | 6.43830E−15 | 4.07609E−15 | −6.91919E−13 | −9.31271E−13 |
| A12 | 0.00000E+00 | 0.00000E+00 | 0.00000E+00 | 0.00000E+00 | −2.16641E−16 |

[Various types of data]

| | INF | 1260 mm |
|---|---|---|
| Focal length | 28.80 | 28.66 |
| F number | 1.24 | 1.25 |
| Total angle of view 2ω | 75.31 | 75.02 |
| Image height Y | 21.63 | 21.63 |
| Total length of lens | 132.26 | 132.26 |

[Variable distance data]

| | INF | 1260 mm |
|---|---|---|
| d0 | ∞ | 1128.1378 |
| d4 | 7.1420 | 6.7193 |
| d8 | 3.0228 | 3.4450 |
| d22 | 6.6117 | 6.0117 |
| d26 | 2.3802 | 2.9808 |
| BF | 17.5511 | 17.5511 |

[Lens group data]

| Group | Starting surface | Focal length |
|---|---|---|
| G1 | 1 | −91.50 |
| G2 | 5 | 58.90 |
| G3 | 9 | 98.20 |
| G4 | 23 | 51.50 |
| G5 | 27 | −79.32 |
| G3a | 9 | −33.02 |
| G3b | 15 | 40.91 |

### Numerical Example 4

Unit: mm
[Surface data]

| Surface number | r | d | nd | vd | θgF |
|---|---|---|---|---|---|
| Object plane | ∞ | (d0) | | | |
| 1 | 79.9095 | 4.5124 | 1.80518 | 25.46 | 0.6157 |
| 2 | 180.3451 | (d2) | | | |
| 3 | 200.3905 | 0.9000 | 1.51742 | 52.15 | 0.5590 |
| 4 | 25.8198 | 7.1040 | | | |
| 5* | 94.0454 | 4.3904 | 1.80610 | 40.73 | 0.5694 |
| 6* | −135.3500 | (d6) | | | |
| 7 | −375.6892 | 1.1915 | 1.48749 | 70.44 | 0.5306 |
| 8 | 33.4117 | 7.4422 | | | |
| 9 | −38.2018 | 1.9348 | 1.69895 | 30.05 | 0.6028 |
| 10 | 94.4096 | 4.7329 | 1.94594 | 17.98 | 0.6546 |
| 11 | −126.8471 | 0.8748 | | | |
| 12 (diaphragm) | ∞ | 2.1774 | | | |
| 13* | 98.9799 | 8.9333 | 1.76802 | 49.24 | 0.5516 |
| 14* | −45.9955 | 0.1500 | | | |
| 15 | −182.9166 | 1.0009 | 1.78880 | 28.43 | 0.6009 |
| 16 | 36.6502 | 5.6564 | 1.75500 | 52.32 | 0.5473 |
| 17 | 118.9691 | 0.6689 | | | |
| 18 | 53.9604 | 0.9957 | 1.85478 | 24.80 | 0.6122 |
| 19 | 27.2000 | 11.9882 | 1.59282 | 68.62 | 0.5440 |
| 20 | −107.0696 | (d20) | | | |
| 21 | 119.6636 | 3.1490 | 1.85033 | 42.70 | 0.5646 |
| 22 | −610.7073 | 0.9000 | 1.71736 | 29.50 | 0.6040 |
| 23 | 131.9346 | 0.1500 | | | |
| 24* | 62.1377 | 6.1694 | 1.76450 | 49.09 | 0.5528 |
| 25* | −96.7368 | (d25) | | | |
| 26 | 265.3800 | 3.6356 | 1.72916 | 54.67 | 0.5453 |
| 27 | −108.7245 | 0.1762 | | | |
| 28 | 999.9854 | 4.8652 | 2.10420 | 17.02 | 0.6631 |
| 29 | −46.7803 | 0.9987 | 1.78880 | 28.43 | 0.6009 |
| 30 | 31.6000 | 5.1917 | | | |
| 31* | −497.5253 | 1.1360 | 1.85135 | 40.10 | 0.5695 |
| 32* | 191.3150 | (BF) | | | |
| image surface | ∞ | | | | |

[Aspherical surface data]

| | 5 surfaces | 6 surfaces | 13 surfaces | 14 surfaces | 24 surfaces |
|---|---|---|---|---|---|
| K | 0.00000 | 0.00000 | 0.00000 | 0.00000 | 0.00000 |
| A4 | −5.50843E−06 | −2.35431E−06 | −3.83949E−07 | 1.62332E−06 | 1.26983E−06 |
| A6 | −2.58748E−09 | −2.10400E−09 | −2.38464E−09 | −2.97927E−09 | −6.40624E−10 |
| A8 | −4.62993E−11 | −2.43714E−11 | −1.23969E−12 | −1.88147E−12 | −8.19666E−12 |
| A10 | 1.38891E−13 | 1.11334E−13 | 1.27103E−15 | −2.37828E−16 | −5.69434E−15 |
| A12 | 0.00000E+00 | 0.00000E+00 | 0.00000E+00 | 0.00000E+00 | 0.00000E+00 |

| | 25 surfaces | 31 surfaces | 32 surfaces |
|---|---|---|---|
| K | 0.00000 | 0.00000 | 0.00000 |
| A4 | 4.61982E−06 | 2.58439E−05 | 4.10690E−05 |
| A6 | −6.48191E−09 | −2.95776E−07 | −2.91383E−07 |
| A8 | −3.17177E−12 | 6.50046E−10 | 7.44110E−10 |
| A10 | −4.98458E−15 | −3.57841E−13 | −2.14493E−13 |
| A12 | 0.00000E+00 | 0.00000E+00 | −8.29753E−16 |

[Various types of data]

| | INF | 1478 mm |
|---|---|---|
| Focal length | 34.67 | 34.16 |
| F number | 1.24 | 1.24 |
| Total angle of view 2ω | 63.40 | 63.57 |
| Image height Y | 21.63 | 21.63 |
| Total length of lens | 128.59 | 128.59 |

[Variable distance data]

| | INF | 1478 mm |
|---|---|---|
| d0 | ∞ | 1349.2275 |
| d2 | 7.4542 | 6.9325 |
| d6 | 2.8661 | 3.3878 |
| d20 | 6.9115 | 6.2697 |
| d25 | 2.5080 | 3.1499 |
| BF | 17.8293 | 17.8293 |

[Lens group data]

| Group | Starting surface | Focal length |
|---|---|---|
| G1 | 1 | 174.70 |
| G2 | 3 | −989.52 |
| G3 | 7 | 105.82 |
| G4 | 21 | 46.60 |
| G5 | 26 | −76.67 |
| G3a | 7 | −41.52 |
| G3b | 13 | 43.94 |

### Numerical Example 5

Unit: mm
[Surface data]

| Surface number | r | d | nd | vd | θgF |
|---|---|---|---|---|---|
| Object plane | ∞ | (d0) | | | |
| 1* | 115.0394 | 1.5000 | 1.59201 | 67.02 | 0.5358 |
| 2* | 39.6227 | 14.6720 | | | |
| 3 | −123.9483 | 1.5000 | 1.72916 | 54.67 | 0.5453 |
| 4 | 47.0768 | 5.2801 | 1.68893 | 31.16 | 0.5990 |
| 5 | 230.8656 | (d5) | | | |
| 6* | 109.1490 | 3.0852 | 1.85135 | 40.10 | 0.5695 |
| 7* | −98.0735 | (d7) | | | |
| 8 | −95.4932 | 0.9923 | 1.48749 | 70.44 | 0.5306 |
| 9 | 48.4515 | 6.5745 | | | |
| 10 | −29.3130 | 0.8000 | 1.68430 | 26.81 | 0.6232 |
| 11 | 147.5931 | 3.7554 | 2.10420 | 17.02 | 0.6631 |
| 12 | −101.0873 | 0.8775 | | | |
| 13 (diaphragm) | ∞ | 2.0696 | | | |
| 14* | 148.4027 | 8.6325 | 1.88202 | 37.22 | 0.5770 |
| 15* | −41.1751 | 1.0272 | | | |
| 16 | −83.3833 | 0.9970 | 1.78880 | 28.43 | 0.6009 |
| 17 | 43.0208 | 5.9288 | 1.72916 | 54.67 | 0.5453 |
| 18 | 473.3018 | 0.6807 | | | |
| 19 | 49.0439 | 0.9930 | 1.85451 | 25.15 | 0.6103 |
| 20 | 27.2000 | 13.0076 | 1.55032 | 75.50 | 0.5401 |
| 21 | −74.5715 | (d21) | | | |
| 22 | −223.7021 | 0.9000 | 1.85451 | 25.15 | 0.6103 |
| 23 | 253.1168 | 0.5623 | | | |
| 24* | 48.4689 | 6.7909 | 1.76802 | 49.24 | 0.5516 |
| 25* | −122.0664 | (d25) | | | |
| 26 | 77.8376 | 4.8196 | 1.72916 | 54.67 | 0.5453 |
| 27 | −97.0943 | 0.1500 | | | |
| 28 | 241.5131 | 4.5434 | 1.98612 | 16.48 | 0.6656 |
| 29 | −53.1134 | 0.9926 | 1.85451 | 25.15 | 0.6103 |
| 30 | 33.8507 | 5.2634 | | | |
| 31* | −500.0000 | 1.0997 | 1.85135 | 40.10 | 0.5695 |
| 32* | 251.7105 | (BF) | | | |
| image surface | ∞ | | | | |

[Aspherical surface data]

| | 1 surfaces | 2 surfaces | 6 surfaces | 7 surfaces | 14 surfaces |
|---|---|---|---|---|---|
| K | 0.00000 | 0.00000 | 0.00000 | 0.00000 | 0.00000 |
| A4 | 7.83206E−06 | 3.68758E−06 | −7.90695E−06 | 3.15033E−06 | 4.88161E−06 |
| A6 | −5.95444E−09 | −1.97667E−09 | 2.61153E−09 | 4.10816E−09 | −6.46948E−09 |
| A8 | 3.35408E−12 | −7.86501E−12 | −6.65409E−11 | −5.24594E−11 | −9.46448E−12 |
| A10 | −4.44137E−16 | 0.00000E+00 | −1.24027E−14 | 0.00000E+00 | 1.46878E−14 |
| A12 | 0.00000E+00 | 0.00000E+00 | 0.00000E+00 | 0.00000E+00 | 0.00000E+00 |

| | 15 surfaces | 24 surfaces | 25 surfaces | 31 surfaces | 32 surfaces |
|---|---|---|---|---|---|
| K | 0.00000 | 0.00000 | 0.00000 | 0.00000 | 0.00000 |
| A4 | 5.04605E−06 | −1.31408E−07 | 2.67238E−06 | 8.39995E−06 | 2.77784E−05 |
| A6 | −7.82063E−10 | −8.28939E−09 | −1.11613E−08 | −2.54153E−07 | −2.57106E−07 |
| A8 | −1.37881E−11 | −5.68225E−12 | 1.37079E−13 | 7.81620E−10 | 1.00732E−09 |
| A10 | 1.44160E−14 | −1.38089E−14 | −1.27364E−14 | −5.32859E−13 | −1.37859E−12 |
| A12 | 0.00000E+00 | 0.00000E+00 | 0.00000E+00 | 0.00000E+00 | 5.23411E−16 |

[Various types of data]

| | INF | 1098 mm |
|---|---|---|
| Focal length | 24.70 | 24.61 |
| F number | 1.24 | 1.25 |
| Total angle of view 2ω | 84.14 | 84.05 |
| Image height Y | 21.63 | 21.63 |
| Total length of lens | 133.63 | 133.63 |

[Variable distance data]

| | INF | 1098 mm |
|---|---|---|
| d0 | ∞ | 964.6255 |
| d5 | 5.1005 | 4.7962 |
| d7 | 2.7839 | 3.0878 |
| d21 | 7.4484 | 6.5846 |
| d25 | 2.3231 | 3.1872 |
| BF | 18.4823 | 18.4823 |

[Lens group data]

| Group | Starting surface | Focal length |
|---|---|---|
| G1 | 1 | −47.62 |
| G2 | 6 | 61.10 |
| G3 | 8 | 76.13 |
| G4 | 22 | 67.32 |
| G5 | 26 | −211.72 |
| G3a | 8 | −40.38 |
| G3b | 14 | 38.78 |

### Numerical Example 6

Unit: mm
[Surface data]

| Surface number | r | d | nd | vd | θgF |
|---|---|---|---|---|---|
| Object plane | ∞ | (d0) | | | |
| 1 | 120.8926 | 3.3509 | 1.84666 | 23.78 | 0.6192 |
| 2 | 306.8164 | (d2) | | | |
| 3 | 126.3024 | 0.9000 | 1.51742 | 52.15 | 0.5590 |
| 4 | 27.5246 | 6.2274 | | | |
| 5* | 45.0000 | 4.6421 | 1.80610 | 40.73 | 0.5694 |
| 6* | −285.7738 | (d6) | | | |
| 7 | −2066.8136 | 1.0078 | 1.48749 | 70.44 | 0.5306 |
| 8 | 21.3943 | 8.3667 | | | |
| 9 | −33.6067 | 2.0692 | 1.69895 | 30.05 | 0.6028 |
| 10 | 117.9840 | 4.1137 | 1.92286 | 20.88 | 0.6390 |
| 11 | −78.6745 | 0.8163 | | | |
| 12 (diaphragm) | ∞ | 2.3138 | | | |
| 13* | 110.5707 | 6.3329 | 1.76802 | 49.24 | 0.5516 |
| 14* | −60.0330 | 0.1500 | | | |
| 15 | 110.9117 | 4.1224 | 1.75500 | 52.32 | 0.5473 |
| 16 | −120.1517 | 1.0158 | 1.85478 | 24.80 | 0.6122 |
| 17 | 27.2000 | 9.8200 | 1.59410 | 60.47 | 0.5552 |
| 18 | −61.9670 | (d18) | | | |
| 19 | −200.7333 | 0.9000 | 1.67270 | 32.17 | 0.5963 |
| 20 | 182.4502 | 1.8118 | | | |
| 21* | 45.8337 | 6.3895 | 1.76802 | 49.24 | 0.5516 |
| 22* | 73.7807 | (d22) | | | |
| 23 | 197.7845 | 2.8057 | 1.78590 | 43.94 | 0.5612 |
| 24 | −144.4221 | 0.1500 | | | |
| 25 | 200.0000 | 4.2390 | 1.94594 | 17.98 | 0.6546 |
| 26 | −50.9976 | 1.1293 | 1.77047 | 29.74 | 0.5951 |
| 27 | 31.6284 | 4.4915 | | | |
| 28* | −500.0000 | 1.1255 | 1.80610 | 40.73 | 0.5694 |
| 29* | 114.4699 | (BF) | | | |
| image surface | ∞ | | | | |

[Aspherical surface data]

| | 5 surfaces | 6 surfaces | 13 surfaces | 14 surfaces | 21 surfaces |
|---|---|---|---|---|---|
| K | 0.00000 | 0.00000 | 0.00000 | 0.00000 | 0.00000 |
| A4 | −6.25289E−06 | −1.93144E−06 | 8.43891E−07 | −1.26374E−06 | −1.77131E−06 |
| A6 | −1.62472E−08 | −1.31903E−08 | −3.32828E−10 | −1.31661E−09 | −1.47259E−09 |
| A8 | −1.21580E−11 | 1.58345E−12 | −2.73552E−11 | −2.87924E−11 | −2.02120E−11 |
| A10 | −8.90998E−14 | −6.47222E−14 | 5.21322E−14 | 4.30521E−14 | 4.36026E−14 |
| A12 | 0.00000E+00 | 0.00000E+00 | 0.00000E+00 | 0.00000E+00 | 0.00000E+00 |

| | 22 surfaces | 28 surfaces | 29 surfaces |
|---|---|---|---|
| K | 0.00000 | 0.00000 | 0.00000 |
| A4 | 3.27386E−06 | 1.43374E−05 | 2.77700E−05 |
| A6 | −7.04768E−09 | −2.46816E−07 | −2.46462E−07 |
| A8 | −5.31985E−12 | 1.03650E−09 | 1.16696E−09 |
| A10 | 3.28319E−14 | −1.39238E−12 | −1.98700E−12 |
| A12 | 0.00000E+00 | 0.00000E+00 | 7.65809E−16 |

[Various types of data]

| | INF | 1529 mm |
|---|---|---|
| Focal length | 36.05 | 35.58 |
| F number | 1.45 | 1.46 |
| Total angle of view 2ω | 62.10 | 62.04 |
| Image height Y | 21.63 | 21.63 |
| Total length of lens | 115.00 | 115.00 |

[Variable distance data]

| | INF | 1529 mm |
|---|---|---|
| d0 | ∞ | 1413.6465 |
| d2 | 5.9558 | 5.5964 |
| d6 | 2.4890 | 2.8475 |
| d18 | 7.1836 | 6.5259 |
| d22 | 2.3268 | 2.9853 |
| BF | 18.7543 | 18.7543 |

[Lens group data]

| Group | Starting surface | Focal length |
|---|---|---|
| G1 | 1 | 233.70 |
| G2 | 3 | 126.83 |
| G3 | 7 | 110.09 |
| G4 | 19 | 49.65 |
| G5 | 23 | −70.14 |
| G3a | 7 | −33.73 |
| G3b | 13 | 41.15 |

### [Conditional Expression Corresponding Value]

| | EX1 | EX2 | EX3 | EX4 | EX5 | EX6 |
|---|---|---|---|---|---|---|
| (1) | 0.47 | 0.47 | 0.46 | 0.45 | 0.42 | 0.43 |
| (2) | 0.0470 | 0.0470 | 0.0470 | 0.0454 | 0.0470 | 0.0387 |
| (3) | 16.48 | 16.48 | 16.48 | 17.02 | 16.48 | 17.98 |
| (4) | 52.14 | 35.84 | 30.02 | 37.65 | 38.19 | 25.96 |
| (5) | 1.82 | 1.36 | 1.22 | 1.36 | 0.81 | 1.29 |
| (6) | 0.004 | 0.027 | 0.022 | 0.014 | 0.333 | 0.110 |
| (7) | 48.60 | 50.64 | 55.13 | 50.64 | 58.48 | 39.59 |
| (8) | 0.0192 | 0.0192 | 0.0225 | 0.0192 | 0.0277 | 0.0157 |
| (9) | 0.0312 | 0.0387 | 0.0470 | 0.0387 | 0.0454 | 0.0283 |
| (10) | 0.17 | 0.15 | 0.15 | 0.15 | 0.12 | 0.16 |
| (11) | 0.30 | 0.32 | 0.31 | 0.30 | 0.31 | 0.27 |
| (12) | −0.99 | −1.02 | −1.15 | −1.20 | −1.63 | −0.94 |
| (13) | 1.11 | 1.14 | 1.42 | 1.27 | 1.57 | 1.14 |

### DESCRIPTION OF REFERENCE NUMERALS AND SIGNS

G1: first lens group
G2: second lens group
G3: third lens group
G3a: third a lens group
G3b: third b lens group
G4: fourth lens group
G5: fifth lens group
S: aperture diaphragm
I: image surface

What is claimed is:

1. An imaging optical system comprising, in order from an object side to an image side: a first lens group G1; a second lens group G2; a third lens group G3 having a positive refractive power; a fourth lens group G4 having a positive refractive power; and a fifth lens group G5 having a negative refractive power, wherein,
when focusing from an infinite distance object to a close distance object, the first lens group G1 remains stationary with respect to an image surface, the second lens group G2 moves to the object side along an optical axis, the third lens group G3 remains stationary with respect to the image surface, the fourth lens group G4 moves to the object side along the optical axis, and the fifth lens group G5 remains stationary with respect to the image surface,
the imaging optical system includes an aperture diaphragm S between a lens surface of the second lens group G2 closest to the image side and a lens surface in the fourth lens group G4 closest to the object side, and
the imaging optical system satisfies a conditional expression shown below,
$$0.30 < D 24 / LT < 0.65 \qquad ( 1 )$$
where
D24: a distance from a lens surface of the second lens group G2 closest to the image side to a lens surface in the fourth lens group G4 closest to the object side at infinity focusing, and
LT: a distance from a lens surface of an entire lens system closest to the object side to the image surface at the infinity focusing.

2. The imaging optical system according to claim 1, wherein
the fifth lens group G5 has at least one positive lens, and
the imaging optical system satisfies conditional expressions shown below,
$$θ gF min 5 p - 0.6483 + 0.0018 \times vd min 5 p > 0.0250 \qquad ( 2 )$$
$$vd min 5 p < 24.00 \qquad ( 3 )$$
where
θgFmin5p: a partial dispersion ratio of a positive lens having a minimum Abbe number of the at least one positive lens included in the fifth lens group G5 with respect to a g line and an F line, and
νdmin5p: an Abbe number of the positive lens having the minimum Abbe number of the at least one positive lens included in the fifth lens group G5, with respect to a d line.

3. The imaging optical system according to claim 2, wherein
the fifth lens group G5 has at least two positive lenses, and
the imaging optical system satisfies a conditional expression shown below,
$$vd max 5 p - vd min 5 p > 15. \qquad ( 4 )$$
where
νdmax5p: an Abbe number of a positive lens having a maximum Abbe number of the at least two positive lenses included in the fifth lens group G5, with respect to the d line, and
νdmin5p: an Abbe number of a positive lens having a minimum Abbe number of the at least two positive lenses included in the fifth lens group G5, with respect to the d line.

4. The imaging optical system according to claim 1, wherein
the fourth lens group G4 consists of one or two positive lenses and one negative lens.

5. The imaging optical system according to claim 1, wherein
the second lens group G2 and the fourth lens group G4 move to the object side with different trajectories along the optical axis when focusing from the infinite distance object to the close distance object.

6. The imaging optical system according to claim 1, wherein
the imaging optical system satisfies conditional expressions shown below,
$$0.5 < ( 1 - β4 \hat{} 2 ) \times β4 R \hat{} 2 < 2.5 \qquad ( 5 )$$
$$\vert ( ( 1 - β2 \hat{} 2 ) \times β2 R \hat{} 2 ) / ( ( 1 - β4 \hat{} 2 ) \times β4 R \hat{} 2 ) \vert < 0. 50 \qquad ( 6 )$$
where
ß4: lateral magnification of the fourth lens group G4 at the infinity focusing,
ß4R: lateral magnification of a lens system positioned closer to the image side than the fourth lens group G4 at the infinity focusing,
ß2: lateral magnification of the second lens group G2 at the infinity focusing, and
ß2R: lateral magnification of a lens system positioned closer to the image side than the second lens group G2 at the infinity focusing.

7. The imaging optical system according to claim 1, wherein
the third lens group G3 has at least two positive lenses and at least two negative lenses, and
the imaging optical system satisfies conditional expressions shown below,
$$vd max 3 p - vd min 3 p > 30 \text{.00} \qquad ( 7 )$$
$$θ gF max 3 p - 0.6483 + 0.0018 \times vd max 3 p > 0.0 \; 120 \qquad ( 8 )$$
$$θ gF min 3 p - 0.6483 + 0.0018 \times vd min 3 p > 0.0200 \qquad ( 9 )$$
where
νdmax3p: an Abbe number of a positive lens having a maximum Abbe number of the at least two positive lenses included in the third lens group G3, with respect to a d line,
νdmin3p: an Abbe number of a positive lens having a minimum Abbe number of the at least two positive lenses included in the third lens group G3, with respect to the d line,
θgFmax3p: a partial dispersion ratio of the positive lens having the maximum Abbe number of the at least two positive lenses included in third lens group G3 with respect to a g line and an F line, and
θgFmin3p: a partial dispersion ratio of the positive lens having the minimum Abbe number of the at least two positive lenses included in the third lens group G3 with respect to the g line and the F line.

8. The imaging optical system according to claim 1, wherein
the imaging optical system satisfies conditional expressions shown below,
$$D 2 S / LT > 0.06 \qquad ( 10 )$$
$$D 4 S / LT > 0.15 \qquad ( 11 )$$
where
D2S: a distance from the lens surface in the second lens group G2 closest to the image side to the aperture diaphragm S at the infinity focusing,
D4S: a distance from the lens surface in the fourth lens group G4 closest to the object side to the aperture diaphragm S at the infinity focusing, and
LT: a distance from the lens surface in the entire lens system closest to the object side to the image surface at the infinity focusing.

9. The imaging optical system according to claim 1, wherein
the third lens group G3 includes a third a lens group G3a having a negative refractive power, the aperture diaphragm S, and a third b lens group G3b having a positive refractive power in order from the object side, and
the imaging optical system satisfies conditional expressions shown below,
$$- 3. < f 3 a / f < - 0.50 \qquad ( 12 )$$
$$0.5 < f 3 b / f < 3.00 \qquad ( 13 )$$
where
f: a focal length of the entire lens system at the infinity focusing,
f3a: a focal length of the third a lens group G3a, and
f3b: a focal length of the third b lens group G3b.

10. An imaging optical system comprising, in order from an object side to an image side: a first lens group G1; a second lens group G2; a third lens group G3 having a positive refractive power; a fourth lens group G4 having a positive refractive power; and a fifth lens group G5 having a negative refractive power, wherein
when focusing from an infinite distance object to a close distance object, the first lens group G1 remains stationary with respect to an image surface, the second lens group G2 moves to the object side along an optical axis, the third lens group G3 remains stationary with respect to the image surface, the fourth lens group G4 moves to the object side along the optical axis, and the fifth lens group G5 remains stationary with respect to the image surface,
the imaging optical system includes an aperture diaphragm S between a lens surface in the second lens group G2 closest to the image side and a lens surface in the fourth lens group G4 closest to the object side,
the fifth lens group G5 includes at least one positive lens, and
the imaging optical system satisfies conditional expressions shown below
$$θ gF min 5 p - 0.6483 + 0.0018 \times vd min 5 p > 0.0250 \qquad ( 2 )$$
$$vd min 5 p < 24.00 \qquad ( 3 )$$
where
θgFmin5p: a partial dispersion ratio of a positive lens having a minimum Abbe number of the at least one positive lens included in fifth lens group G5 with respect to a g line and an F line, and
νdmin5p: an Abbe number of a positive lens having a minimum Abbe number of the at least one positive lens included in the fifth lens group G5, with respect to a d line.

11. The imaging optical system according to claim 10, wherein
the fifth lens group G5 has at least two positive lenses, and
the imaging optical system satisfies a conditional expression shown below,
$$vd max 5 p - vd min 5 p > 15. \qquad ( 4 )$$
where
νdmax5p: an Abbe number of a positive lens having a maximum Abbe number of the at least two positive lenses included in the fifth lens group G5, with respect to the d line, and
νdmin5p: an Abbe number of a positive lens having a minimum Abbe number of the at least two positive lenses included in the fifth lens group G5, with respect to the d line.

12. The imaging optical system according to claim 10, wherein
the fourth lens group G4 consists of one or two positive lenses and one negative lens.

13. The imaging optical system according to claim 10, wherein
the second lens group G2 and the fourth lens group G4 move to the object side with different trajectories along the optical axis when focusing from the infinite distance object to the close distance object.

14. The imaging optical system according to claim 10, wherein
the imaging optical system satisfies conditional expressions shown below,
$$0.5 < ( 1 - β4 \hat{} 2 ) \times β4 R \hat{} 2 < 2.5 \qquad ( 5 )$$
$$\vert ( ( 1 - β2 \hat{} 2 ) \times β2 R \hat{} 2 ) / ( ( 1 - β4 \hat{} 2 ) \times β4 R \hat{} 2 ) \vert < 0.5 \qquad ( 6 )$$
where
ß4: lateral magnification of the fourth lens group G4 at infinity focusing,
ß4R: lateral magnification of a lens system positioned closer to the image side than the fourth lens group G4 at the infinity focusing,
ß2: lateral magnification of the second lens group G2 at the infinity focusing, and
ß2R: lateral magnification of a lens system positioned closer to the image side than the second lens group G2 at the infinity focusing.

15. The imaging optical system according to claim 10, wherein
the third lens group G3 has at least two positive lenses and at least two negative lenses, and
the imaging optical system satisfies conditional expressions shown below,
$$vd max 3 p - vd min 3 p > 30.00 \qquad ( 7 )$$
$$θ gF max 3 p - 0.6483 + 0.0018 \times vd max 3 p > 0 \text{.0120} \qquad ( 8 )$$
$$θ gF min 3 p - 0.6483 + 0.0018 \times vd min 3 p > 0.0200 \qquad ( 9 )$$
where
νdmax3p: an Abbe number of a positive lens having a maximum Abbe number of the at least two positive lenses included in the third lens group G3, with respect to the d line,
νdmin3p: an Abbe number of a positive lens having a minimum Abbe number of the at least two positive lenses included in the third lens group G3, with respect to the d line,
θgFmax3p: a partial dispersion ratio of the positive lens having the maximum Abbe number of the at least two positive lenses included in third lens group G3 with respect to the g line and the F line, and
θgFmin3p: a partial dispersion ratio of the positive lens having the minimum Abbe number of the at least two positive lenses included in the third lens group G3 with respect to the g line and the F line.

16. The imaging optical system according to claim 10, wherein
the imaging optical system satisfies conditional expressions shown below,
$$D 2 S / LT > 0.06 \qquad ( 10 )$$
$$D 4 S / LT > 0.15 \qquad ( 11 )$$
where
D2S: a distance from a lens surface in the second lens group G2 closest to the image side to the aperture diaphragm S at infinity focusing,
D4S: a distance from a lens surface in the fourth lens group G4 closest to the object side to the aperture diaphragm S at the infinity focusing, and
LT: a distance from a lens surface of an entire lens system closest to the object side to the image surface at the infinity focusing.

17. The imaging optical system according to claim 10, wherein
the third lens group G3 includes a third a lens group G3a having a negative refractive power, the aperture diaphragm S, and a third b lens group G3b having a positive refractive power in order from the object side, and
the imaging optical system satisfies conditional expressions shown below,
$$- 3. < f 3 a / f < - 0.50 \qquad ( 12 )$$
$$0.5 < f 3 b / f < 3.00 \qquad ( 13 )$$
where
f: a focal length of an entire lens system at infinity focusing,
f3a: a focal length of the third a lens group G3a, and
f3b: a focal length of the third b lens group G3b.
